(19) United States
(12) Patent Application Publication
(10) Pub. No.: US 2024/0045254 A1
(43) Pub. Date: Feb. 8, 2024

(54) IMAGE FORMING UNIT AND PROJECTOR

(71) Applicant: SEIKO EPSON CORPORATION, Tokyo (JP)

(72) Inventors: Norikazu KADOTANI, Azumino-shi (JP); Yuki NAITO, Matsumoto-shi (JP); Tomoaki MIYASHITA, Shimosuwa-machi (JP); Masanobu NAKANISHI, Azumino-shi (JP)

(21) Appl. No.: 18/366,781

(22) Filed: Aug. 8, 2023

(30) Foreign Application Priority Data
Aug. 8, 2022 (JP) 2022-126686

(51) Int. Cl. G02F 1/1333; G03B 21/00; G03B 21/16

(52) U.S. Cl. CPC G02F 1/133385; G03B 21/006; G03B 21/16

(57) ABSTRACT

An image formation unit includes a first panel module having a first liquid crystal panel output blue image light, a second panel module having a second liquid crystal panel output green image light, and a third panel module having a third liquid crystal panel output red image light, wherein the first panel module includes a first heat diffuser which transfers heat with the first liquid crystal panel, a first Peltier element which transfers heat to and from the first heat diffuser, and a first cooler which in heat transfers with the first Peltier element, and the second panel module includes a second heat diffuser which transfers heat with the second liquid crystal panel, a second Peltier element which transfers heat to and from the second heat diffuser, and a second cooler which in heat transfers with the second Peltier element.

The present application is based on, and claims priority from JP Application Serial Number 2022-126686, filed Aug. 8, 2022, the disclosure of which is hereby incorporated by reference herein in its entirety.

### BACKGROUND

### 1. Technical Field

The present disclosure relates to an image forming unit and a projector.

### 2. Related Art

In the past, there has been known a projector which modulates light emitted from a light source, and then projects the result (see, e.g., JP-A-2015-225209 (Patent Literature 1) and JP-A-2015-108697 (Patent Literature 2)).

The projection type display device described in Patent Literature 1 is provided with an illumination device, an optical unit, and a projection optical system. The optical unit is provided with three liquid crystal light valves for modulating incident light, and in addition, provided with a liquid crystal cell which functions as an optical filter for absorbing light in a specific wavelength range out of the light emitted from the illumination device.

The liquid crystal cell has a first substrate, a second substrate, and a liquid crystal layer. The liquid crystal layer is sandwiched between the first substrate and the second substrate. On a surface at an opposite side to the liquid crystal layer in the first substrate, there is disposed a heater, and the heater is a resistive element, and is arranged along an outer edge of the pair of substrates so as to have a frame shape to heat the first substrate. Thus, the liquid crystal layer is heated.

The projector described in Patent Literature 2 is provided with an optical unit including a light source, and a cooling device. The optical unit is provided with three liquid crystal panels as a light modulation device, and the cooling device circulates a cooling liquid such as propylene glycol along an annular flow channel to thereby cool the liquid crystal panels. Specifically, the cooling device is provided with an optical element holder, a liquid pressure feeder, a supply tank, a heat exchange unit, a plurality of pipe-like members, and a cooling fan. Among these, the optical element holder incorporates a flow channel through which the cooling liquid flows, and holds the liquid crystal panels. The heat exchange unit is coupled to the optical element holder via the plurality of pipe-like members. Through the heat exchange unit, there flows the cooling liquid from the optical element holder. The heat exchange unit is provided with a heat receiver, a Peltier element as a thermoelectric conversion element, a heatsink, and so on. The heat receiver receives heat of the liquid crystal panels via the optical element holder and the cooling liquid, and the Peltier element transfers the heat received by the heat receiver to the heatsink. Further, the cooling fan feeds cooling air to the heatsink to release the heat of the heatsink.

When using the projector under the circumstances in which the temperature is low such as cold climates, or when an amount of light entering the liquid crystal panels is low, the temperature of the liquid crystal of the liquid crystal panels is low. Therefore, since the responsiveness of the liquid crystal is low, there occurs when an image cannot appropriately be formed. In contrast, by providing the heater described in Patent Literature 1 to the liquid crystal panels to raise the temperature of the liquid crystal, it is possible to enhance the responsiveness of the liquid crystal.

On the other hand, the liquid crystal panels deteriorate due to light and the temperature, and the life of the liquid crystal panels shortens, and therefore, it becomes necessary to cool the liquid crystal panels. In contrast, by combining the cooling device using the liquid cooling medium described in Patent Literature 2, it is possible to efficiently cool the liquid crystal panels.

However, when combining the heater described in Patent Literature 1 and the cooling device described in Patent Literature 2 with each other, and heating the liquid cooling medium with the heater to heat the liquid crystal panels, since the liquid cooling medium is high in specific heat, a rise in temperature of the liquid crystal panels is slow, and temperature responsiveness is affected.

Further, for example, when switching from a low luminance mode in which an amount of incident light to the liquid crystal panels is small to a high luminance mode in which the amount of the incident light is large, it is desirable for the panel to promptly be cooled. However, it requires time to make the liquid cooling medium at a temperature suitable for the low luminance mode reach the liquid cooling medium at a temperature suitable for the high luminance mode. Therefore, there is a possibility that it is unachievable to promptly perform the temperature adjustment of the liquid crystal panels. In particular, out of a red liquid crystal panel, a green liquid crystal panel, and a blue liquid crystal panel, the green liquid crystal panel and the blue liquid crystal panel are more significantly affected by the heat compared to the red liquid crystal panel, and therefore, an increase in cooling efficiency is required.

Therefore, there has been demanded a configuration in which the temperature adjustment of the liquid crystal panels can promptly be performed.

### SUMMARY

An image forming unit according to a first aspect of the present disclosure includes a first panel module having a first liquid crystal panel configured to output blue image light, a second panel module having a second liquid crystal panel configured to output green image light, and a third panel module having a third liquid crystal panel configured to output red image light, wherein the first panel module includes a first heat diffuser which is configured to transfer heat with the first liquid crystal panel, and in which the heat received diffuses, a first Peltier element which has a first transfer surface, and a first reverse surface at an opposite side to the first transfer surface, and which transfers heat between the first transfer surface and the first heat diffuser, and a first cooler configured to transfer heat with the first reverse surface, and the second panel module includes a second heat diffuser which is configured to transfer heat with the second liquid crystal panel, and in which the heat received diffuses, a second Peltier element which has a second transfer surface, and a second reverse surface at an opposite side to the second transfer surface, and which transfers heat between the second transfer surface and the second heat diffuser, and a second cooler configured to transfer heat with the second reverse surface.

A projector according to a second aspect of the present disclosure includes the image forming unit according to the first aspect, a light source configured to emit light which enters each of the first liquid crystal panel, the second liquid crystal panel, and the third liquid crystal panel, and a projection optical unit configured to project the blue image light emitted from the first liquid crystal panel, the green image light emitted from the second liquid crystal panel, and the red image light emitted from the third liquid crystal panel.

### BRIEF DESCRIPTION OF THE DRAWINGS

FIG. 1 is a schematic diagram showing a configuration of a projector according to an embodiment.

FIG. 2 is a perspective view showing an example of an image forming unit in the embodiment.

FIG. 3 is an exploded perspective view showing an example of the image forming unit in the embodiment.

FIG. 4 is a perspective view showing an A-type panel module in the embodiment.

FIG. 5 is a perspective view showing the A-type panel module in the embodiment.

FIG. 6 is an exploded perspective view showing the A-type panel module in the embodiment.

FIG. 7 is an exploded perspective view showing the A-type panel module in the embodiment.

FIG. 8 is a cross-sectional view showing the A-type panel module in the embodiment.

FIG. 9 is a perspective view showing a B-type panel module in the embodiment.

FIG. 10 is an exploded perspective view showing the B-type panel module in the embodiment.

FIG. 11 is an exploded perspective view showing a C-type panel module in the embodiment.

FIG. 12 is a diagram showing an example of a relationship between luminance and the panel module of the projector according to the embodiment.

FIG. 13 is a schematic diagram showing a configuration of a temperature adjustment device provided to a projector of an ultrahigh luminance model according to the embodiment.

FIG. 14 is a schematic diagram showing a configuration of a temperature adjustment device provided to a projector of a high luminance model according to the embodiment.

FIG. 15 is a side view showing a B-type panel module and a second driver in the embodiment.

FIG. 16 is a schematic diagram showing a configuration of a temperature adjustment device provided to a projector of a medium luminance model according to the embodiment.

FIG. 17 is a schematic diagram showing a configuration of a temperature adjustment device provided to a projector of a low luminance model according to the embodiment.

FIG. 18 is a cross-sectional view showing a modification of a heat diffuser in the embodiment.

### DESCRIPTION OF EMBODIMENTS

An embodiment of the present disclosure will hereinafter be described based on the drawings.

### Schematic Configuration of Projector

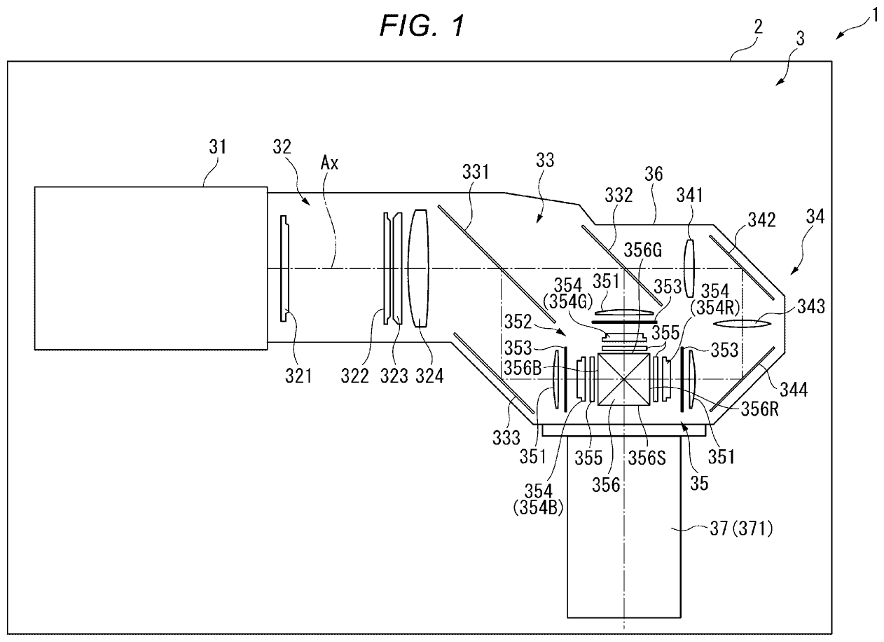

FIG. 1 is a schematic diagram showing a configuration of a projector 1 according to the present embodiment.

The projector 1 according to the present embodiment is an image display device which modulates light emitted from a light source 31 disposed inside to thereby form image light corresponding to image information, and then projects the image light thus formed on a projection target surface such as a screen in an enlarged manner. The projector 1 is an example of an electronic apparatus according to the present disclosure.

As shown in FIG. 1, the projector 1 is provided with an exterior housing 2, and an image projection device 3 housed in the exterior housing 2. Besides the above, although not shown in the drawings, the projector 1 is provided with a control device for controlling operations of the projector 1, a power supply device for supplying electronic components constituting the projector 1 with electrical power, and a cooling device for cooling a cooling target constituting the projector 1.

### Configuration of Image Projection Device

The image projection device 3 forms the image

light corresponding to the image information input from the control device, and then projects the image light thus formed. The image projection device 3 is provided with the light source 31, a homogenizing optical system 32, a color separation optical system 33, a relay optical system 34, an image forming device 35, an optical component housing 36, and a projection optical unit 37.

The light source 31 emits illumination light to the homogenizing optical system 32. As a configuration of the light source 31, there can be illustrated, for example, a configuration having a solid-state light source for emitting blue light as excitation light, and a wavelength conversion element for converting at least a part of the blue light emitted from the solid-state light source into the fluorescence including the green light and the red light. It should be noted that as another configuration of the light source 31, there can be illustrated a configuration having a light source lamp such as a super-high pressure mercury lamp, or a configuration having light emitting elements individually emitting the blue light, the green light, and the red light.

The homogenizing optical system 32 homogenizes the light emitted from the light source 31. The light thus homogenized illuminates pixel areas of panel modules 354 described later via the color separation optical system 33 and the relay optical system 34. The homogenizing optical system 32 is provided with two lens arrays 321, 322, a polarization conversion element 323, and a superimposing lens 324.

The color separation optical system 33 separates the light having entered the color separation optical system 33 from the homogenizing optical system 32 into colored light beams of red, green, and blue. The color separation optical system 33 is provided with two dichroic mirrors 331, 332 and a reflecting mirror 333 for reflecting the blue light having been separated by the dichroic mirror 331.

The relay optical system 34 is disposed on a light path of the red light longer than light paths of other colored light to suppress a loss of the red light. The relay optical system 34 is provided with an incident side lens 341, a relay lens 343, and reflecting mirrors 342, 344. In the present embodiment, it is assumed that the red light is guided to the relay optical system 34. However, this is not a limitation, and it is also possible to adopt a configuration in which, for example, the colored light beam longer in light path than other colored light beams is set as the blue light, and the blue light is guided to the relay optical system 34.

The image forming device 35 modulates each of the colored light beams of red, green, and blue having entered the image forming device 35, and then combines the colored light beams thus modulated with each other to form the image light. The image forming device 35 is provided with three field lenses 351 disposed corresponding to the colored light beams entering the image forming device 35, and a single image forming unit 352.

### Configuration of Image Forming Unit

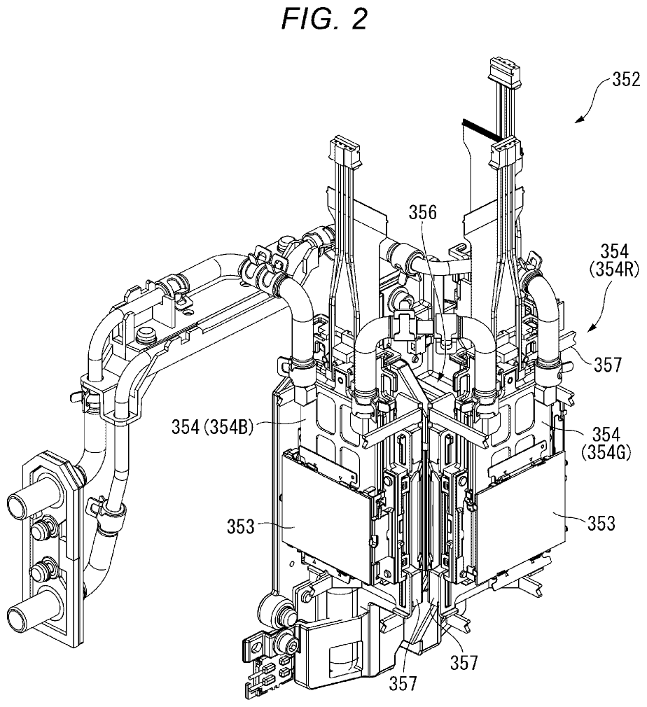

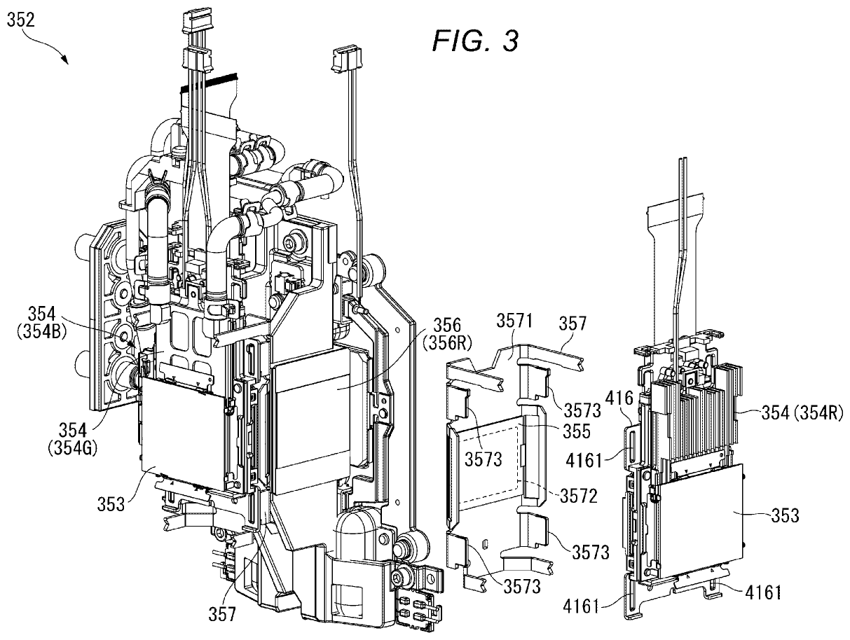

FIG. 2 is a perspective view showing an example of the image forming unit 532, and FIG. 3 is an exploded perspective view showing an example of the image forming unit 352. It should be noted that FIG. 2 and FIG. 3 illustrate the image forming unit 352 provided to the projector 1 of a high luminance model described later.

As shown in FIG. 1 through FIG. 3, the image forming unit 352 is provided with three incident side polarization plates 353, three panel modules 354, three exit side polarization plates 355, a single color combining optical system 356, and in addition, has three support members 357 as shown in FIG. 2 and FIG. 3.

The panel modules 354 each modulate the light, which has been emitted from the light source 31, based on an image signal input from a control device. Specifically, the panel modules 354 each modulate the colored light beam entering the panel module 354 from corresponding one of the incident side polarization plates 353 in accordance with the image signal input from the control device, and then emit the colored light beam thus modulated. The three panel modules 354 include a first panel module 354B for the blue light, a second panel module 354G for the green light, and a third panel module 354R for the red light. The first panel module 354B outputs blue image light, the second panel module 354G emits green image light, and the third panel module 354R emits the red image light.

Although described later in detail, as the panel module which can be adopted as the panel modules 354, there can be cited three types, namely an A-type panel module 4A, a B-type panel module 4B, and a C-type panel module 4C. The three panel modules 354 adopted in the image forming unit 352 are selectively adopted from the A-type panel module 4A, the B-type panel module 4B, and the C-type panel module 4C based on the amount of light entering the panel module 354 from the light source 31. Configurations of the panel modules 4A, 4B, and 4C will be described later in detail.

The color combining optical system 356 combines the three colored light beams modulated by the respective panel modules 354B, 354G, and 354R with each other to form the image light. In the present embodiment, the color combining optical system 356 is formed of a cross dichroic prism having a substantially rectangular solid shape, and the color combining optical system 356 is provided with three planes of incidence of light 356B, 356G, and 356R, and a single light exit surface 356S.

The blue light having been modulated by the first panel module 354B enters the plane of incidence of light 356B. The green light having been modulated by the second panel module 354G enters the plane of incidence of light 356G. The red light having been modulated by the third panel module 354R enters the plane of incidence of light 356R. The planes of incidence of light 356B, 356G, and 356R are respectively provided with the support members 357.

The light exit surface 356S emits the image light combined in the inside of the color combining optical system 356. The image light emitted from the light exit surface 356S enters the projection optical unit 37.

The color combining optical system 356 is formed of a cross dichroic prism in the present embodiment, but can be constituted by a plurality of dichroic mirrors.

The support members 357 are respectively disposed for the planes of incidence of light 356B, 356G, and 356R of the color combining optical system 356 shown in FIG. 1 to support the panel modules 354B, 354G, and 354R corresponding thereto. As shown in FIG. 2 and FIG. 3, the support members 357 each have an attaching portion 3571 having a rectangular frame shape and four arm portions 3573.

The attaching portion 3571 is attached to corresponding one of the planes of incidence of light 356B, 356G, and 356R. The attaching portion 3571 has an opening 3572 having a rectangular shape around the center thereof. On a surface at a light incidence side in the attaching portion 3571, there is disposed the exit side polarization plate 355 so as to cover the opening 3572. The light having passed through the exit side polarization plate 355 enters corresponding one of the planes of incidence of light 356B, 356G, and 356R via the opening 3572.

The four arm portions 3573 protrude toward the light incidence side from four corners of the attaching portion 3571. The four arm portions 3573 are respectively inserted into four through openings 4161 provided to a holding frame 416 of the panel module 354, and are fixed to inner surfaces of the through openings 4161 with an adhesive or the like. Thus, the panel modules 354 and the color combining optical system 356 are integrated with each other.

The homogenizing optical system 32, the color separation optical system 33, the relay optical system 34, and the image forming device 35 all described above are housed inside the optical component housing 36 shown in FIG. 1. It should be noted that an optical axis Ax as a design optical axis is set in the image projection device 3, and the optical component housing 36 holds the homogenizing optical system 32, the color separation optical system 33, the relay optical system 34, and the image forming device 35 at predetermined positions on the optical axis Ax. The light source 31 and the projection optical unit 37 are disposed at predetermined positions on the optical axis Ax.

The projection optical unit 37 projects the image light entering the projection optical unit 37 from the image forming device 35 on the projection target surface such as a screen. The projection optical unit 37 can be configured as a combination lens provided with, for example, a plurality of lenses not shown, and a lens tube 371 for housing the plurality of lenses.

### Types of Panel Module

As described above, as each of the first panel module 354B, the second panel module 354G, and the third panel module 354R, one of the A-type panel module 4A, the B-type panel module 4B, and the C-type panel module 4C described below is selectively used. The panel modules 4A, 4B, and 4C will hereinafter be described.

### Configuration of A-Type Panel Module

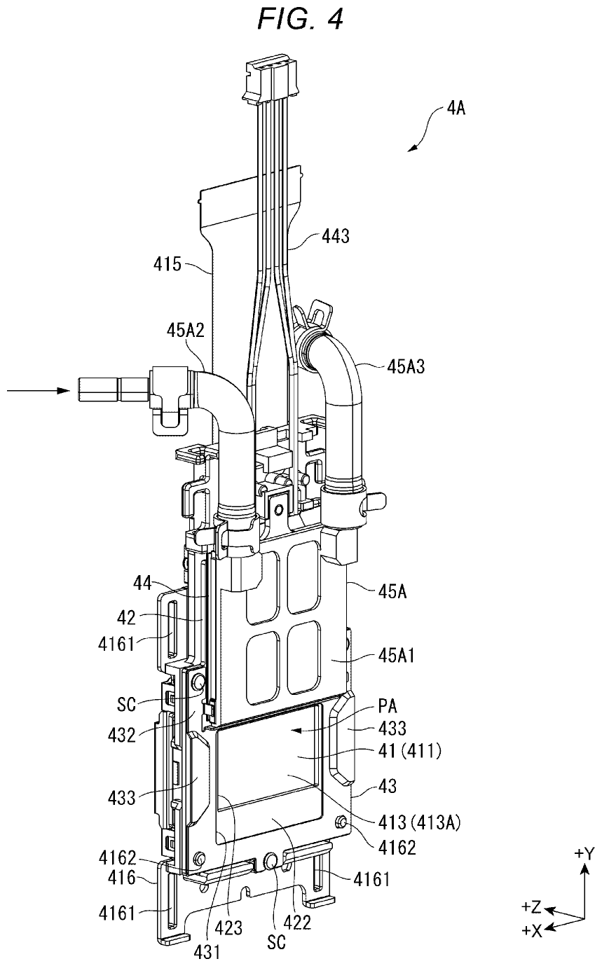

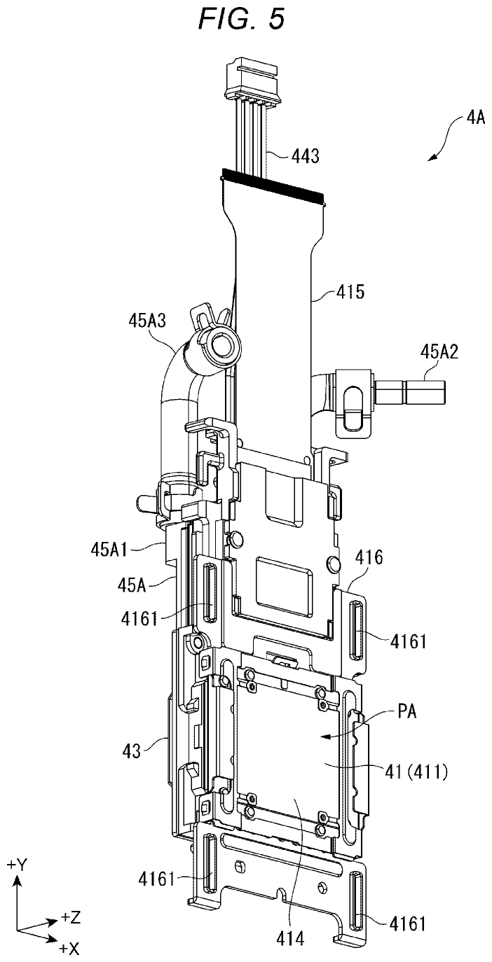

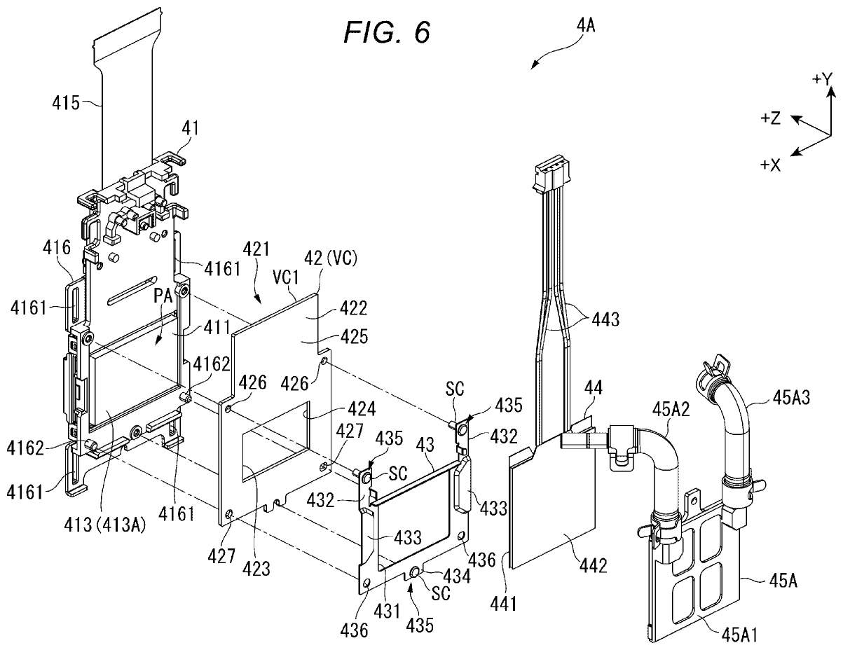

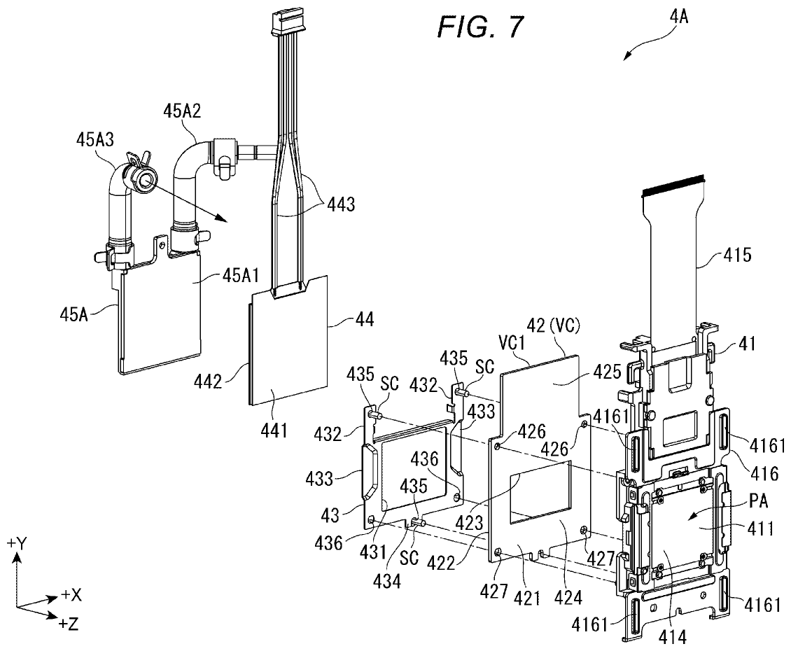

FIG. 4 is a perspective view showing the A-type panel module 4A viewed from the light incidence side, and FIG. 5 is a perspective view showing the A-type panel module 4A viewed from the light exit side. FIG. 6 is an exploded perspective view showing the A-type panel module 4A viewed from the light incidence side, and FIG. 7 is an exploded perspective view showing the A-type panel module 4A viewed from the light exit side.

As shown in FIG. 4 through FIG. 7, the A-type panel module 4A is provided with a liquid crystal panel 41, a heat diffuser 42, a holding member 43, a thermoelectric conversion device 44, and a cooler 45A.

In the following description, three directions perpendicular to each other are defined as a +X direction, a +Y direction, and a +Z direction, respectively. In the present embodiment, the +Z direction is set as a proceeding direction of the light entering the A-type panel module 4A. A leftward direction when viewing the A-type panel module 4A along the +Z direction so that the +Y direction coincides with the upward direction is defined as +X direction. Although not shown in the drawings, an opposite direction to the +X direction is defined as a −X direction, an opposite direction to the +Y direction is defined as a −Y direction, and an opposite direction to the +Z direction is defined as a −Z direction. In other words, the +Z direction with respect to the A-type panel module 4A is the light exit side with respect to the A-type panel module 4A, and the −Z direction with respect to the A-type panel module 4A is the light incidence side with respect to the A-type panel module 4A.

Further, an axis along the +X direction or the −X direction is defined as an X axis, an axis along the +Y direction or the −Y direction is defined as a Y axis, and an axis along the +Z direction or the −Z direction is defined as a Z axis.

### Configuration of Liquid Crystal Panel

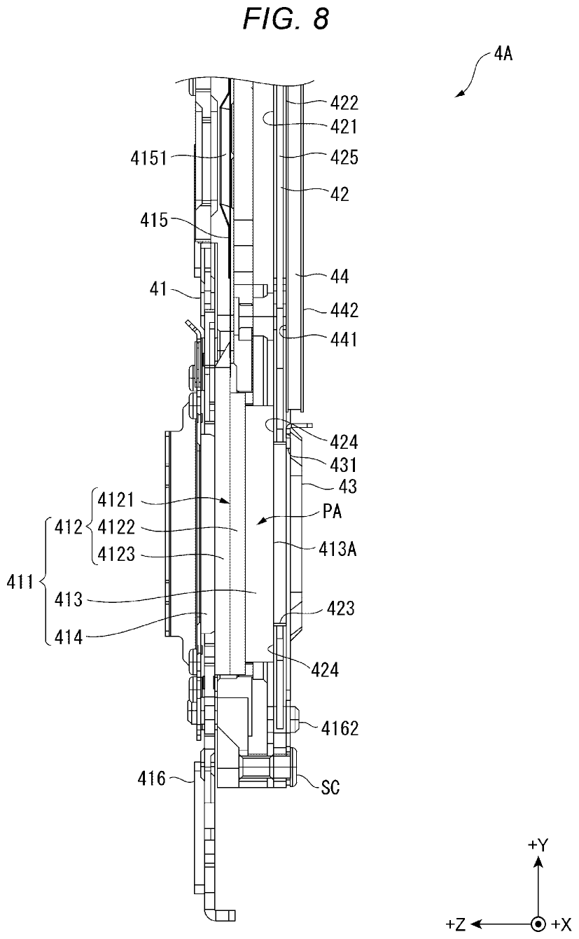

FIG. 8 is a diagram showing a cross-sectional surface along the Y-Z plane of the A-type panel module 4A. It should be noted that the illustration of the cooler 45A is omitted in FIG. 8.

The liquid crystal panel 41 is a device working on the incident light. As shown in FIG. 6, the liquid crystal panel 41 is provided with a light transmissive liquid crystal element 411, an FPC (Flexible Printed Circuit) 415, and the holding frame 416. It should be noted that the light transmissive liquid crystal element 411 is abbreviated as a liquid crystal element 411.

The liquid crystal element 411 modulates the incident light, and then emits the result. In the detailed description, the liquid crystal element 411 emits the modulated light obtained by modulating the incident light, along the proceeding direction of the incident light. The liquid crystal element 411 is a heat source. The liquid crystal element 411 is provided with an optical operator 412, and an incident side dust-proof substrate 413 and an exit side dust-proof substrate 414 which sandwich the optical operator 412 in the Z axis.

### Configuration of Optical Operator

The optical operator 412 has a liquid crystal layer 4121, and an opposed substrate 4122 and a pixel substrate 4123 which sandwich the liquid crystal layer 4121 in the Z axis.

The liquid crystal layer 4121 is formed of liquid crystal molecules encapsulated between the opposed substrate 4122 and the pixel substrate 4123.

The opposed substrate 4122 is arranged at the light incidence side with respect to the liquid crystal layer 4121. In the opposed substrate 4122, there is disposed an opposed electrode on a surface opposed to the liquid crystal layer 4121.

The pixel substrate 4123 is arranged at the light incidence side with respect to the liquid crystal layer 4121. In the pixel substrate 4123, there is disposed a plurality of pixel electrodes on a surface opposed to the liquid crystal layer 4121. It should be noted that an area in which the plurality of pixel electrodes are arranged in the optical operator 412 when viewed from the -Z direction as the light incidence side is a pixel area PA for emitting the image light in the liquid crystal panel 41, and a single pixel is formed by an area in which each of the pixel electrodes is arranged in the pixel area PA.

The opposed substrate 4122 and the pixel substrate 4123 are coupled to the FPC 415, and an arrangement state of the liquid crystal molecules which form the liquid crystal layer 4121 is changed in accordance with the image signal supplied from the FPC 415. Thus, the optical operator 412 modulates the incident light.

### Configuration of Incident Side Dust-Proof Substrate

The incident side dust-proof substrate 413 is a light transmissive substrate disposed in a portion corresponding to the pixel area PA on the plane of incidence of light of the opposed substrate 4122. When viewing the liquid crystal panel 41 from the −Z direction, the incident side dust-proof substrate 413 is disposed in a heat-transferable manner on the plane of incidence of light of the opposed substrate 4122 so as to cover the pixel area PA. The incident side dust-proof substrate 413 prevents dust and so on from adhering to the plane of incidence of light of the opposed substrate 4122 to cause shadows of the dust and so on to show up in the image light.

It should be noted that the heat diffuser 42 described later is coupled to the incident side dust-proof substrate 413. In the detailed description, a contact portion 424 of the heat diffuser 42 makes heat transmissive contact with a plane of incidence of light 413A in the incident side dust-proof substrate 413. The plane of incidence of light 413A is a heat transfer surface for transferring the heat generated in the optical operator 412 of the liquid crystal element 411 to the heat diffuser 42. In other words, the liquid crystal panel 41 has the transmissive liquid crystal element 411 for emitting the incident light, and the plane of incidence of light 413A as the heat transfer surface for transferring the heat of the light transmissive liquid crystal element 411.

### Configuration of Exit Side Dust-Proof Substrate

The exit side dust-proof substrate 414 is a light transmissive substrate disposed in a portion corresponding to the pixel area PA on the light exit surface of the pixel substrate 4123. When viewing the liquid crystal panel 41 from the +Z direction, the exit side dust-proof substrate 414 is disposed on the light exit surface of the pixel substrate 4123 in a heat-transferable manner so as to cover the pixel area PA. The exit side dust-proof substrate 414 prevents dust and so on from directly adhering to the light exit surface of the pixel substrate 4123 to cause shadows of the dust and so on to show up in the image light.

### Configuration of FPC

As shown in FIG. 8, the FPC 415 extends toward the +Y direction from the opposed substrate 4122 and the pixel substrate 4123 to be coupled to the control device described above. The FPC 415 has a driver circuit 4151 for driving the optical operator 412, and the driver circuit 4151 applies a drive signal corresponding to the image signal input from the control device to the pixel substrate 4123.

### Configuration of Holding Frame

The holding frame 416 holds the liquid crystal element 411 and the FPC 415, and in addition, supports the heat diffuser 42, the holding member 43, the thermoelectric conversion device 44, and the cooler 45A. As shown in FIG. 5 and FIG. 7, the holding frame 416 is formed to have a rectangular shape elongated in the +Y direction when viewed from the light exit side. Although not shown in the drawings, the holding frame 416 has an opening through which the light entering the liquid crystal element 411 and the light emitted from the liquid crystal element 411 pass. The holding frame 416 has four through openings 4161 penetrating the holding frame 416 along the Z axis. In each of the four through openings 4161, there is inserted corresponding one of arm parts 3573 provided to the support member 357 described above.

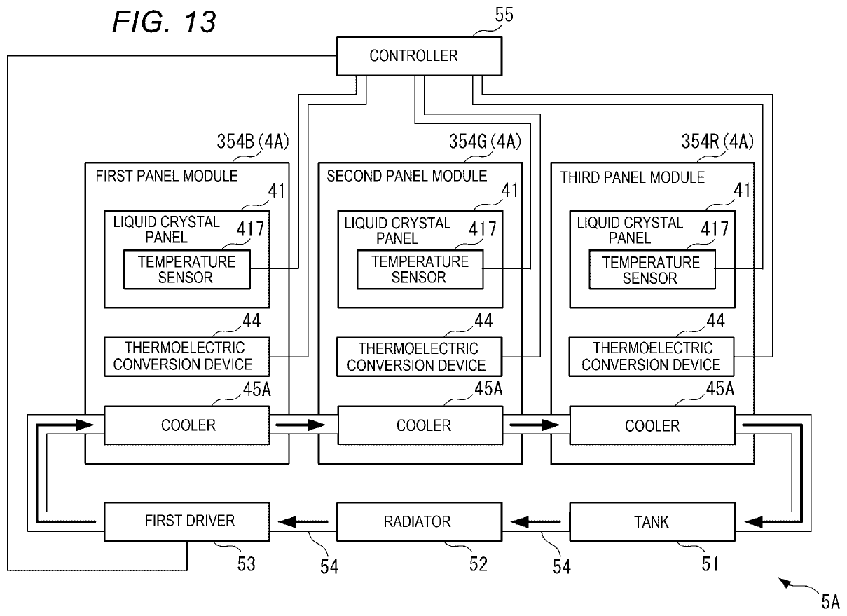

Besides the above, as described in FIG. 13 described later, the liquid crystal panel 41 is further provided with a temperature sensor 417. The temperature sensor 417 is provided to, for example, the holding frame 416, and detects the temperature of the liquid crystal element 411.

### Configuration of Heat Diffuser

The heat diffuser 42 is for receiving the heat of the liquid crystal element 411 from the plane of incidence of light 413A of the incident side dust-proof substrate 413, and for diffusing the heat thus received using the heat diffuser 42. As shown in FIG. 6 and FIG. 7, the heat diffuser 42 is formed to have a substantially rectangular shape elongated along the Y axis when viewed from the +Z direction, and is arranged at the light incidence side with respect to the liquid crystal panel 41. In the detailed description, the heat diffuser 42 is arranged between the liquid crystal element 411 and the thermoelectric conversion device 44. The heat diffuser 42 is provided with a first surface 421, a second surface 422, an opening 423, a contact portion 424, an extending portion 425, two holes 426, and two holes 427.

The first surface 421 is a surface opposed to the liquid crystal panel 41 in the heat diffuser 42. In other words, the first surface 421 is a surface opposed to the liquid crystal element 411 in the heat diffuser 42. In other words, the first surface 421 is a surface at the light exit side in the heat diffuser 42.

The second surface 422 is a surface at an opposite side to the first surface 421 in the heat diffuser 42. The holding member 43 and the thermoelectric conversion device 44 described later have contact with the second surface 422.

The through opening 423, the light entering the liquid crystal element 411 is made to pass toward the +Z direction when the heat diffuser 42 is attached to the holding frame 416. In other words, the opening 423 is a through opening penetrating the heat diffuser 42 along the +Z direction. The opening 423 is formed to have a substantially rectangular shape corresponding to the pixel area PA when viewed from the light incidence side.

The contact portion 424 is disposed on a circumferential edge of the opening 423 on the first surface 421. The contact portion 424 makes contact with the plane of incidence of light 413A as the heat transfer surface to receive the heat of the liquid crystal element 411 from the plane of incidence of light 413A.

The extending portion 425 is a portion extending in a direction crossing the incident direction of the light to the liquid crystal element 411 from the contact portion 424 in the heat diffuser 42. In the detailed description, the extending portion 425 is a portion extending from the contact portion 424 in a direction of getting away from the pixel area PA for emitting the image light in the liquid crystal panel 41. Specifically, the extending portion 425 is a portion extending from the contact portion 424 toward the +Y direction crossing the Z axis.

The two holes 426 are disposed at the +Y direction side of the opening 423. In each of the two holes 426, there is inserted a screw SC to be fixed to the holding frame 416.

The two holes 427 are disposed at the −Y direction side of the opening 423. As shown in FIG. 6, in each of the two holes 427, there is inserted a protrusion 4162 provided to the holding frame 416. In other words, the protrusions 4162 are each a positioning protrusion, and the two holes 427 are each a positioning hole.

In the heat diffuser 42, the heat of the liquid crystal element 411 received in the contact portion 424 is diffused to the extending portion 425. Further, the heat diffused to the extending portion 425 is absorbed by the thermoelectric conversion device 44 disposed on the second surface 422.

In the present embodiment, the heat diffuser 42 is a vapor chamber VC having a sealed housing VC1 in which a working fluid changeable between the vapor phase and the liquid phase is encapsulated.

The first surface 421 is a surface opposed to the liquid crystal element 411 in the sealed housing VC1, and the second surface 422 is a surface at an opposite side to the first surface 421 in the sealed housing VC1. The contact portion 424 and the extending portion 425 are disposed in the sealed housing VC1, and the contact portion 424 is a heat receiver for receiving the heat of the liquid crystal element 411 in the sealed housing VC1.

A part of the working fluid in the liquid phase encapsulated in the sealed housing VC1 evaporates due to the heat of the liquid crystal element 411 received by the contact portion 424 to change to the working fluid in the vapor phase, and diffuse in the sealed housing VC1.

A part of the working fluid in the vapor phase transfers the heat to a portion low in temperature in the sealed housing VC1. Thus, the working fluid in the vapor phase is condensed to change to the working fluid in the liquid phase. The working fluid having changed to one in the liquid phase moves again to the heat receiver along an inner surface of the sealed housing VC1.

A portion in the sealed housing VC1 to which the heat is transferred is a heat dissipater, and the heat thus transferred is released by the heat dissipater. In the second surface 422, the extending portion 425 is provided with the thermoelectric conversion device 44, and therefore, in the sealed housing VC1, a portion provided with the thermoelectric conversion device 44 becomes the heat dissipater.

### Configuration of Holding Member

As shown in FIG. 6 and FIG. 7, the holding member 43 is formed to have a substantially rectangular frame shape. The holding member 43 is fixed to the holding frame 416 with the screws SC, and holds the incident side polarization plate 353 shown in FIG. 1 at the light incidence side. The holding member 43 has an opening 431, two arm parts 432, two fixation portions 433, a protruding portion 434, three holes 435, and two holes 436.

The opening 431 is an opening having a rectangular shape, and is disposed at a position corresponding to the pixel area PA when the holding member 43 is fixed to the holding frame 416. The light emitted toward the +Z direction from the incident side polarization plate 353 passes through the opening 431, then further passes through the opening 423 of the heat diffuser 42, and then enters the liquid crystal element 411.

One of the two arm parts 432 protrudes toward the +Y direction from an end portion at the +X direction side in the holding member 43, and the other of the two arm parts 432 protrudes toward the +Y direction from an end portion at the −X direction side in the holding member 43.

One of the two fixation portions 433 is disposed at the +X direction side of the opening 431, and the other of the two fixation portions 433 is disposed at the −X direction side of the opening 431. Each of the fixation portions 433 protrudes toward the −Z direction, and the incident side polarization plate 353 is fixed at the light incidence side with an adhesive or the like.

The protruding portion 434 protrudes toward the −Y direction from the center on the X axis in the holding member 43.

Two of the three holes 435 are provided respectively to the two arm parts 432, and the remaining one of the three holes 435 is provided to the protruding portion 434. To each of the holes 435, there is inserted the screw SC to be fixed to the holding frame 416 along the +Z direction.

The two holes 436 are disposed on the corners at the −Y direction side of the opening 431. In each of the two holes 436, there is inserted the protrusion 4162 as a positioning protrusion provided to the holding frame 416. In other words, the two holes 436 are the positioning holes.

As described above, the holding member 43 is fixed to the holding frame 416 together with the heat diffuser 42, and holds the incident side polarization plate 353.

### Configuration of Thermoelectric Conversion Device

The thermoelectric conversion device 44 is coupled to the heat diffuser 42, absorbs the heat from the heat diffuser 42, and then releases the heat. As shown in FIG. 6 and FIG. 7, the thermoelectric conversion device 44 has a first surface 441, a second surface 442, and a lead wire 443.

The first surface 441 is a surface opposed to the heat diffuser 42 in the thermoelectric conversion device 44, and corresponds to a transfer surface. In the detailed description, the first surface 441 is a surface having contact with the extending portion 425 in the thermoelectric conversion device 44. In other words, the first surface 441 is a surface facing to the +Z direction in the thermoelectric conversion device 44.

The second surface 442 is a surface opposed to the first surface 441 in the thermoelectric conversion device 44, and corresponds to a reverse surface to the transfer surface. In other words, the second surface 442 is a surface facing to the −Z direction in the thermoelectric conversion device 44. To the second surface 442, there is attached the cooler 45A.

The lead wire 443 extends toward the +Y direction from an end portion at the +Y direction side in the thermoelectric conversion device 44. The lead wire 443 is coupled to a temperature control device described later. In other words, an operation of the thermoelectric conversion device 44 is controlled by the temperature control device.

Such a thermoelectric conversion device 44 actively absorbs the heat transferred from the extending portion 425 with the first surface 441, and releases the heat thus absorbed from the second surface 442 to the cooler 45A due to the electrical power supplied from the lead wire 443.

In the present embodiment, the thermoelectric conversion device 44 is a Peltier element. Therefore, by reversing the polarity of the thermoelectric conversion device 44, it is possible to supply the heat from the first surface 441 to the extending portion 425. In other words, it is possible to heat the liquid crystal element 411 of the liquid crystal panel 41 via the heat diffuser 42. On this occasion, in the heat diffuser 42, the working fluid in the liquid phase located around the extending portion 425 changes to the working fluid in the vapor phase due to the heat supplied from the thermoelectric conversion device 44, and the working fluid in the vapor phase diffuses inside the sealed housing VC1. Further, a part of the working fluid in the vapor phase transfers the heat to the contact portion 424, and the heat is supplied from the contact portion 424 to the liquid crystal element 411. It should be noted that when supplying the heat from the first surface 441 to the heat diffuser 42, the second surface 442 functions as the heat absorbing surface to absorb the heat from the cooler 45A. The cooler 45A is coupled to the thermoelectric conversion device 44, but is not coupled to the heat diffuser 42 and the liquid crystal panel 41. Further, since the thermoelectric conversion device 44 functions as a heat insulation member, when the thermoelectric conversion device 44 heats the liquid crystal element 411, a cooling effect due to the thermoelectric conversion device 44 does not act on the liquid crystal element 411.

### Configuration of Cooler

The cooler 45A is coupled to the second surface 442 of the thermoelectric conversion device 44 to release the heat transferred from the thermoelectric conversion device 44. The cooler 45A is provided with a cooler main body 45A1, an inflow tube 45A2, and an outflow tube 45A3.

Although the detailed illustration will be omitted, the cooler main body 45A1 incorporates a plurality of flow channels through which a liquid cooling medium can flow, and the liquid cooling medium supplied from the inflow tube 45A2 flows inside. In other words, the cooler 45A is a cold plate configured so that the liquid cooling medium can flow inside.

The cooler main body 45A1 is formed of a material such as metal high in thermal conductivity, and is fixed to the second surface 442 in a heat-transferable manner. The heat transferred from the second surface 442 to the cooler main body 45A1 is transferred to the liquid cooling medium flowing through the cooler main body 45A1. Thus, the cooler main body 45A1, by extension, the liquid crystal element 411, is cooled.

The inflow tube 45A2 is a tube-like member for making the liquid cooling medium inflow into the cooler main body 45A1.

The outflow tube 45A3 is a tube-like member from which the liquid cooling medium having flowed through the cooler main body 45A1.

The flow of the liquid cooling medium through the cooler 45A is performed by the temperature control device described later.

### Configuration of B-Type Panel Module

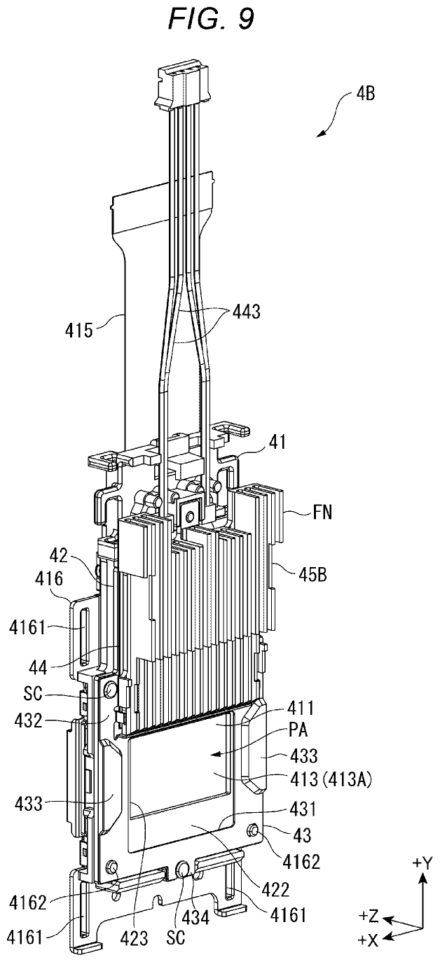

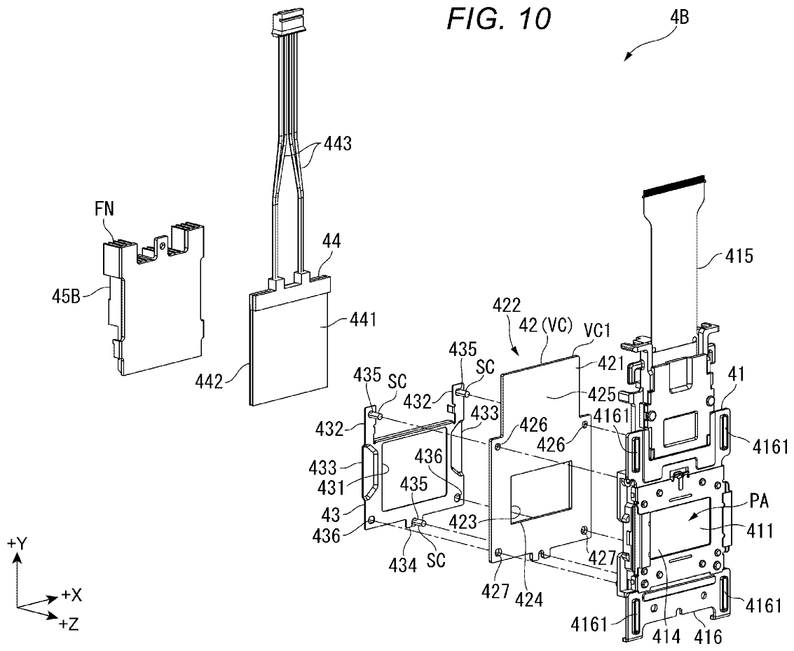

FIG. 9 is a perspective view showing the B-type panel module 4B viewed from the light incidence side. FIG. 10 is an exploded perspective view showing the B-type panel module 4B viewed from the light exit side.

Then, the B-type panel module 4B will be described.

Similarly to the A-type panel module 4A, the B-type panel module 4B emits the modulated light obtained by modulating the incident light along the incident direction of the light. As shown in FIG. 9 and FIG. 10, the B-type panel module 4B is provided with substantially the same configuration and functions as those of the A-type panel module 4A except the point that a cooler 45B is provided instead of the cooler 45A. In other words, the B-type panel module 4B is provided with the liquid crystal panel 41, the heat diffuser 42, the holding member 43, the thermoelectric conversion device 44, and the cooler 45B.

### Configuration of Cooler

The cooler 45B is coupled to the second surface 442 of the thermoelectric conversion device 44 to release the heat transferred from the thermoelectric conversion device 44. In the present embodiment, the cooler 45B is a heatsink having a plurality of fins FN. The cooler 45B transfers the heat of the liquid crystal element 411 transferred from the thermoelectric conversion device 44, to a cooling gas made to flow by the temperature control device described later, to release the heat of the liquid crystal element 411.

### Configuration of C-Type Panel Module

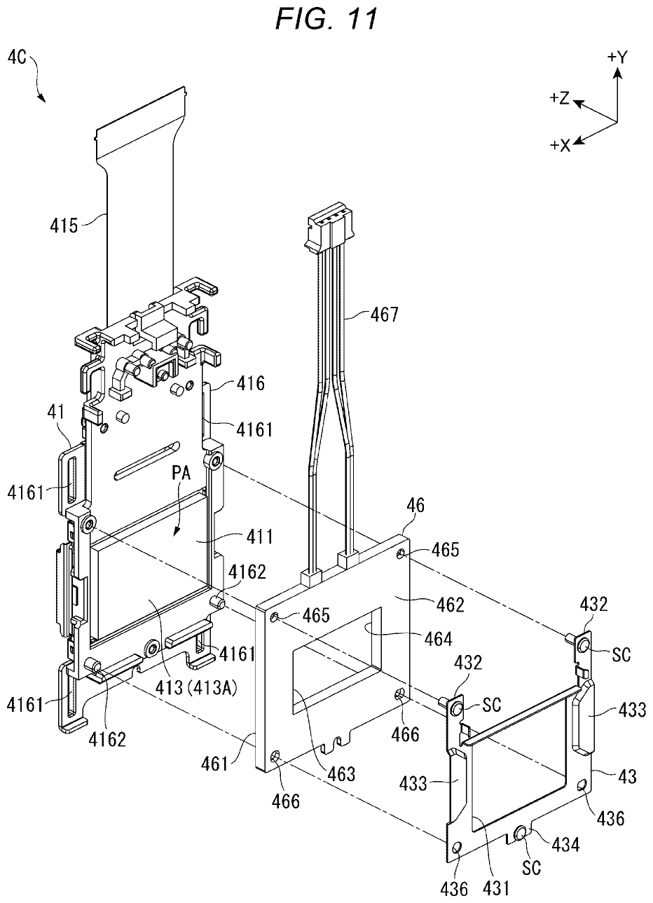

FIG. 11 is an exploded perspective view showing the C-type panel module 4C viewed from the light incidence side.

Then, the C-type panel module 4C will be described.

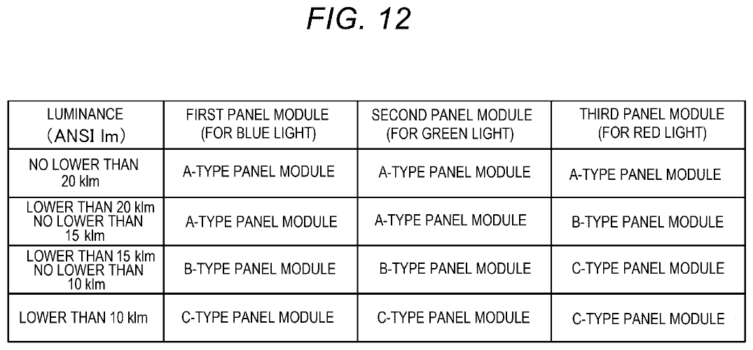

Similarly to the A-type panel module 4A, the C-type panel module 4C emits the modulated light obtained by modulating the incident light along the incident direction of the light. As shown in FIG. 12, the C-type panel module 4C is provided with substantially the same configuration and functions as those of the A-type panel module 4A except the point that a heater 46 is provided instead of the heat diffuser 42, the thermoelectric conversion device 44, and the cooler 45A. In other words, the C-type panel module 4C is provided with the liquid crystal panel 41, the holding member 43, and the heater 46.

### Configuration of Heater

The heater 46 generates heat with electrical power supplied thereto to heat the liquid crystal element 411 of the liquid crystal panel 41. The heater 46 is configured by sandwiching a sheet heating element on the Z axis with a pair of substrates. The heater 46 is provided with a first surface 461, a second surface 462, an opening 463, a contact portion 464, two holes 465, two holes 466, and a lead wire 467.

The first surface 461 is opposed to the liquid crystal element 411 in the heater 46. In other words, the first surface 461 is a surface at the light exit side in the heater 46.

The second surface 462 is a surface at the opposite side to the first surface 461. In other words, the second surface 462 is a surface at the light incidence side in the heater 46.

The opening 463 penetrates the heater 46 on the Z axis. The opening 463 transmits the light emitted from the incident side polarization plate 353 held by the holding member 43 disposed at the light incidence side to the heater 46, and makes the light enter the liquid crystal element 411. It should be noted that the opening 463 is formed to have a size corresponding to the pixel area PA in the heater 46.

The contact portion 464 is a portion making contact with the liquid crystal element 411 in the heater 46. In the detailed description, the contact portion 464 makes contact with the plane of incidence of light 413A of the incident side dust-proof substrate 413 in the liquid crystal element 411. The contact portion 464 is arranged on the first surface 461. Specifically, the contact portion 464 is arranged in a circumferential edge portion of the opening 463 on the first surface 461.

The two holes 465 are disposed at the +Y direction side of the opening 463. In the two holes 465, there are inserted the screws SC for attaching the holding member 43 to the holding frame 416 in the +Z direction.

The two holes 466 are disposed at the −Y direction side of the opening 463. In the two holes 466, there are inserted the protrusions 4162 as the positioning protrusions provided to the holding frame 416 from the −Z direction.

The lead wire 467 extends toward the +Y direction. The lead wire 467 is coupled to the temperature control device described later, and supplies the electrical power supplied from the temperature control device, to the sheet heating element. In other words, the heat generation by the heater 46 is controlled by the temperature control device.

By such a heater 46 as well, it is possible to heat the liquid crystal element 411 constituting the liquid crystal panel 41 similarly to the thermoelectric conversion device 44.

### Selection of Panel Module According To Luminance of Projector

As described above, as each of the first panel module 354B, the second panel module 354G, and the third panel module 354R, one of the A-type panel module 4A, the B-type panel module 4B, and the C-type panel module 4C described above is selectively used. For example, each of the panel modules 354B, 354G, and 354R is selected from the A-type panel module 4A, the B-type panel module 4B, and the C-type panel module 4C in accordance with the luminance of the projector 1, and is used.

FIG. 12 is a diagram showing an example of a relationship between the luminance of the projector in the specification and the panel module to be selected.

In the example shown in FIG. 12, in the projector 1 in which ANSI (American National Standard Institute) lm (lumen) as an index of the luminance in the specification is no lower than 20 klm, it is possible to adopt the A-type panel module 4A as each of the panel modules 354B, 354G, and 354R. This projector 1 is defined as an ultrahigh luminance model.

In the projector 1 in which the ANSI lm is no lower than 15 klm and lower than 20 klm, it is possible to adopt the A-type panel module 4A as each of the panel modules 354B, 354G, and it is possible to adopt the B-type panel module 4B as the panel module 354R. This projector 1 is defined as a high luminance model.

In the projector 1 in which the ANSI lm is no lower than 10 klm and lower than 15 klm, it is possible to adopt the B-type panel module 4B as each of the panel modules 354B, 354G, and it is possible to adopt the C-type panel module 4C as the panel module 354R. This projector 1 is defined as a medium luminance model.

In the projector 1 in which the ANSI lm is lower than 10 klm, it is possible to adopt the C-type panel module 4C as each of the panel modules 354B, 354G, and 354R. This projector 1 is defined as a low luminance model.

It should be noted that a range of the luminance of each of the models is not limited to the above, and can arbitrarily be changed.

Configurations of the temperature control devices provided to the projectors 1 as the respective models will hereinafter be described.

### Case of Ultrahigh Luminance Model

FIG. 13 is a schematic diagram showing a configuration of a temperature control device 5A provided to the projector 1 as the ultrahigh luminance model.

When the projector 1 is the ultrahigh luminance model, the A-type panel module 4A is adopted as each of the panel modules 354B, 354G, and 354R as described above. In this case, it is possible to couple the outflow tube 45A3 of the cooler 45A provided to one of the three A-type panel modules 4A and the inflow tube 45A2 of the cooler 45A provided to one of the rest of the A-type panel modules 4A to each other.

In the example shown in FIG. 13, the outflow tube 45A3 of the first panel module 354B is coupled to the inflow tube 45A2 of the second panel module 354G. The outflow tube of the second panel module 354G is coupled to the inflow tube 45A2 of the third panel module 354R.

It should be noted that the inflow tube 45A2 of the first panel module 354B is coupled to a first driver 53 of the temperature control device 5A, and the outflow tube of the third panel module 354R is coupled to a tank 51 of the temperature control device 5A.

The projector 1 as the ultrahigh luminance model is provided with the temperature control device 5A shown in FIG. 13.

The temperature control device 5A controls the temperature of each of the panel modules 354B, 354G, and 354R. The temperature control device 5A is provided with the tank 51, a radiator 52, the first driver 53, tube-like members 54, and a controller 55. Out of these constituents, the tube-like members 54 are each formed so that the liquid cooling medium can flow inside.

The tank 51 retains the liquid cooling medium which circulates the coolers 45A of the respective panel modules 354B, 354G, and 354R.

The radiator 52 is coupled to the tank 51 via the tube-like member 54. The radiator 52 cools the liquid cooling medium which inflows from the tank 51.

The first driver 53 is coupled to the radiator 52 via the tube-like member 54. The first driver 53 is a pump, and pressure-feeds the liquid cooling medium cooled in the radiator 52 to the inflow tube 45A2 of the first panel module 354B. The liquid cooling medium delivered by the first driver 53 flows through the cooler 45A of the first panel module 354B, the cooler 45A of the second panel module 354G, and the cooler 45A of the third panel module 354R in sequence, and then inflows into the tank 51. The liquid cooling medium having flowed into the tank 51 inflows once again into the first driver 53 via the radiator 52.

The controller 55 controls the thermoelectric conversion devices 44 of the respective panel modules 354B, 354G, and 354R and the first driver 53 based on the detection result by the temperature sensors 417 of the respective panel modules 354B, 354G, and 354R to thereby control the temperatures of the liquid crystal elements 411 of the respective panel modules 354B, 354G, and 354R.

For example, when the temperature of at least one of the three liquid crystal elements 411 exceeds an upper limit value of a predetermined optimum temperature range, the controller 55 performs cooling processing of the liquid crystal elements 411. As the cooling processing, there is included at least one of an increase in flow rate of the liquid cooling medium according to a rise in output of the first driver 53, and an increase in heat absorption amount of the thermoelectric conversion device 44 according to a rise in output of the thermoelectric conversion device 44.

Further, for example, when the temperature of at least one of the three liquid crystal elements 411 is lower than a lower limit value of the predetermined optimum temperature range, the controller 55 performs heating processing of the liquid crystal elements 411. As the heating processing, there is included at least one of a decrease in flow rate of the liquid cooling medium according to a decrease in output of the first driver 53, and a heating operation by the thermoelectric conversion device 44. The heating operation by the thermoelectric conversion device 44 includes at least one of a decrease in heat absorption amount of the thermoelectric conversion device 44 according to the decrease in output of the thermoelectric conversion device 44, and heating of the heat diffuser 42, by extension, the liquid crystal element 411 by the thermoelectric conversion device 44.

It should be noted that in the configuration described above, it is assumed that the three panel modules 354 are coupled so that the liquid cooling medium flows through the first panel module 354B, the second panel module 354G, and the third panel module 354R in this order. However, this is not a limitation, and the order of the circulation of the liquid cooling medium in the three panel modules 354 is not limited to the above.

On the other hand, since the blue light having a wavelength approximate to the wavelength of the ultraviolet light enters the first panel module 354B, the deterioration by the light high in energy is the most apt to occur in the first panel module 354B which the blue light enters. Further, in general, in white light which is used for forming an image in good condition, the intensity of the green light is higher than other colored light beams, and therefore, a deterioration due to temperature is apt to occur. On the grounds described above, by making the liquid cooling medium the lowest in temperature flow through the first panel module 354B, and then making the liquid cooling medium having flowed through the first panel module 354B flow through the second panel module 354G in advance of the third panel module 354R, it is possible to effectively cool the panel modules 354, and thus, it is possible to prevent the deterioration of the panel modules 354.

Further, it is assumed that the temperature control device 5A described above is provided with a single driver 53 for making the liquid cooling medium flow through the three panel modules 354. In other words, it is assumed that the temperature control device 5A is provided with a circulation flow channel of the liquid cooling medium including the three panel modules 354 and the single first driver 53. However, this is not a limitation, and it is possible for the temperature control device 5A to be provided with a circulation flow channel of the liquid cooling medium including a single panel module 354 and the single first driver 53. In other words, it is possible for the temperature control device 5A to be provided with the single first driver 53 corresponding one-to-one to the single panel module 354.

### Case of High Luminance Model

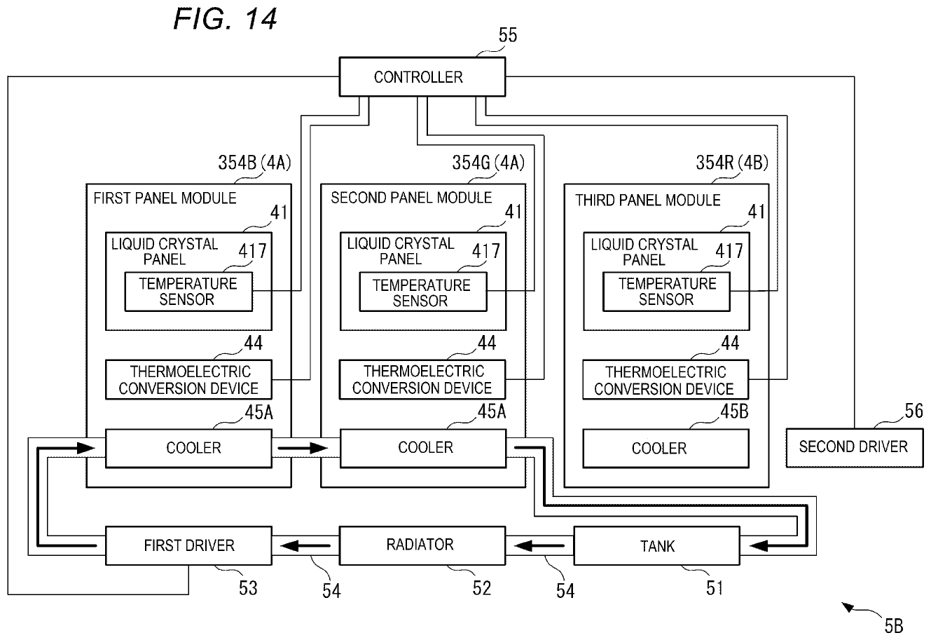

FIG. 14 is a schematic diagram showing a configuration of a temperature control device 5B provided to the projector 1 as the high luminance model.

When the projector 1 is the high luminance model, the A-type panel module 4A is adopted as each of the panel modules 354B, 354G, and the B-type panel module 4B is adopted as the third panel module 354R as described above. In this case, it is possible to couple the outflow tube 45A3 of the cooler 45A provided to one of the two A-type panel modules 4A and the inflow tube 45A2 of the cooler 45A provided to the other of the A-type panel modules 4A to each other.

In the example shown in FIG. 14, the outflow tube 45A3 of the first panel module 354B is coupled to the inflow tube 45A2 of the second panel module 354G.

It should be noted that the inflow tube 45A2 of the first panel module 354B is coupled to the first driver 53 of the temperature control device 5B, and the outflow tube 45A3 of the second panel module 354G is coupled to the tank 51 of the temperature control device 5A.

The projector 1 as the high luminance model is provided with the temperature control device 5B shown in FIG. 14.

Similarly to the temperature control device 5A, the temperature control device 5B controls the temperature of each of the panel modules 354B, 354G, and 354R. The temperature control device 5B is further provided with a second driver 56. In other words, the temperature control device 5B is provided with the tank 51, the radiator 52, the first driver 53, the tube-like members 54, the controller 55, and the second driver 56.

It should be noted that in the temperature control device 5B, the liquid cooling medium delivered by the first driver 53 to the inflow tube 45A2 of the first panel module 354B flows through the cooler 45A of the first panel module 354B, and the cooler 45A of the second panel module 354G in sequence, and then inflows into the tank 51. The liquid cooling medium having flowed into the tank 51 inflows once again into the first driver 53 via the radiator 52.

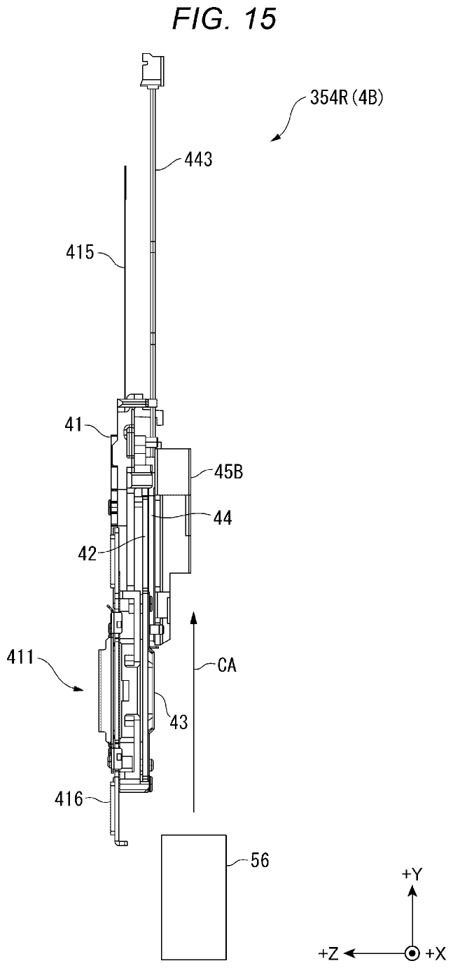

FIG. 15 is a side view showing the B-type panel module 4B viewed from the +X direction, and the second driver 56.

As shown in FIG. 15, the second driver 56 is formed of a cooling fan for circulating a cooling gas CA. The cooling gas CA receives the heat from the cooling target to thereby cool the cooling target.

For example, when the cooling gas CA flows through the cooler 45B of the B-type panel module 4B, the cooler 45B transfers the heat of the liquid crystal element 411 transferred from the thermoelectric conversion device 44, to the cooling gas CA to thereby release the heat of the liquid crystal element 411.

In such a temperature control device 5B, for example, when the temperature of at least one of the liquid crystal elements 411 of the respective panel modules 354B, 354G exceeds the upper limit value of the predetermined optimum temperature range, the controller 55 performs the cooling processing of the liquid crystal elements 411 of the respective panel modules 354B, 354G similarly to the case in the temperature control device 5A.

Further, when the temperature of the liquid crystal element 411 of the panel module 354R exceeds the upper limit value of the predetermined optimum temperature range, the controller 55 performs at least one of an increase in flow rate of the cooling gas CA according to a rise in output of the second driver 56, and an increase in heat absorption amount of the thermoelectric conversion device 44 according to a rise in output of the thermoelectric conversion device 44.

In contrast, when the temperature of at least one of the liquid crystal elements 411 of the respective panel modules 354B, 354G is lower than the lower limit value of the predetermined optimum temperature range, the controller performs the heating processing of the liquid crystal elements 411 of the respective panel modules 354B, 354G similarly to the case in the temperature control device 5A.

Further, when the temperature of the liquid crystal element 411 of the panel module 354R is lower than the lower limit value of the predetermined optimum temperature range, the controller 55 performs at least one of a decrease in flow rate of the cooling gas CA according to a decrease in output of the second driver 56, and a heating operation by the thermoelectric conversion device 44.

It should be noted that in the configuration described above, it is assumed that the two panel modules 354B, 354G are coupled so that the liquid cooling medium flows through the first panel module 354B and the second panel module 354G in this order. However, this is not a limitation, and the order of the circulation of the liquid cooling medium in the two panel modules 354B, 354G is not limited to the above.

Further, it is assumed that the temperature control device 5B described above is provided with a single first driver 53 for making the liquid cooling medium flow through the two panel modules 354B, 354G. In other words, it is assumed that the temperature control device 5B is provided with a circulation flow channel of the liquid cooling medium including the two panel modules 354B, 354G and the single first driver 53. However, this is not a limitation, and it is possible for the temperature control device 5B to be provided with a circulation flow channel of the liquid cooling medium including a single panel module 354 and the single first driver 53. In other words, it is possible for the temperature control device 5B to be provided with the single first driver 53 corresponding one-to-one to the single panel module 354.

### Case of Medium Luminance Model

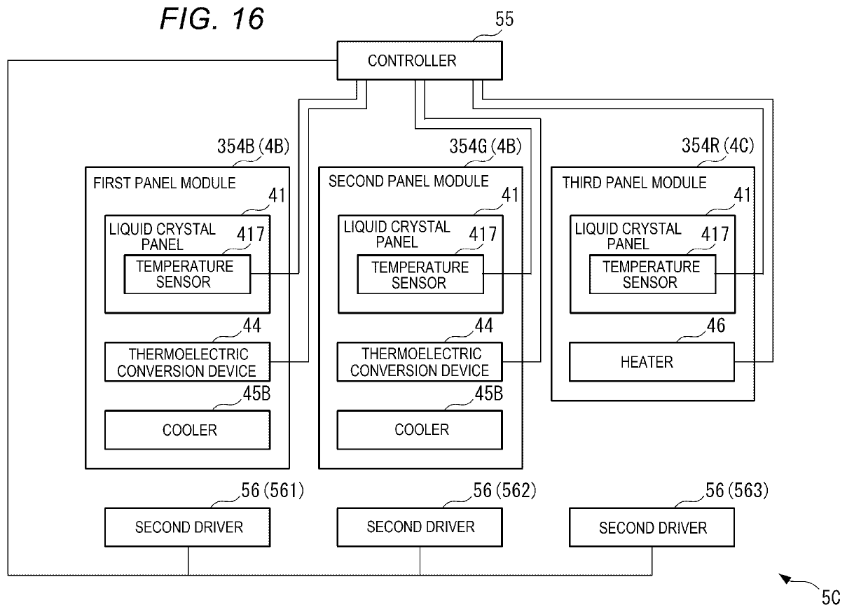

FIG. 16 is a schematic diagram showing a configuration of a temperature control device 5C provided to the projector 1 as the medium luminance model.

When the projector 1 is the medium luminance model, the B-type panel module 4B is adopted as each of the panel modules 354B, 354G, and the C-type panel module 4C is adopted as the third panel module 354R as described above.

The projector 1 as the medium luminance model is provided with the temperature control device 5C shown in FIG. 16.

The temperature control device 5C controls the temperatures of the liquid crystal elements 411 of the respective panel modules 354B, 354G, and 354R. The temperature control device 5C is provided with the controller 55 and the three second drivers 56.

Out of the three second drivers 56, the second driver 561 makes the cooling gas CA flow through the first panel module 354B, and the second driver 562 makes the cooling gas CA flow through the second panel module 354G. Thus, the heat of the liquid crystal elements 411 is transferred to the cooling gas CA from the coolers 45B of the respective panel modules 354B, 354G.

Out of the three second drivers 56, the second driver 563 makes the cooling gas CA flow through the third panel module 354R. Thus, the heat of the liquid crystal element 411 is transferred to the cooling gas CA from the holding frame 416 and so on of the third panel module 354R.

In the temperature control device 5C, for example, when the temperature of the liquid crystal element 411 of the first panel module 354B exceeds the upper limit value of the predetermined optimum temperature range, the controller 55 performs at least one of an increase in flow rate of the cooling gas CA according to a rise in output of the second driver 561, and an increase in heat absorption amount of the thermoelectric conversion device 44 according to a rise in output of the thermoelectric conversion device 44 of the first panel module 354B. The same applies to when the temperature of the liquid crystal element 411 of the second panel module 354G exceeds the upper limit value of the predetermined optimum temperature range.

When the temperature of the liquid crystal element 411 of the third panel module 354R exceeds the upper limit value of the predetermined optimum temperature range, the controller 55 performs an increase in flow rate of the cooling gas CA according to a rise in output of the second driver 563.

On the other hand, when the temperature of the liquid crystal element 411 of the first panel module 354B is lower than the lower limit value of the predetermined optimum temperature range, the controller 55 performs at least one of a decrease in flow rate of the cooling gas CA according to a decrease in output of the second driver 561, and a heating operation by the thermoelectric conversion device 44 of the first panel module 354B. The same applies to when the temperature of the liquid crystal element 411 of the second panel module 354G is lower than the lower limit value of the predetermined optimum temperature range.

When the temperature of the liquid crystal element 411 of the third panel module 354R is lower than the lower limit value of the predetermined optimum temperature range, the controller 55 performs at least one of a decrease in flow rate of the cooling gas CA according to a decrease in output of the second driver 563, and heating of the liquid crystal element 411 by the heater 46 according to a rise in output of the heater 46. It should be noted that except when the temperature of the liquid crystal element 411 of the third panel module 354R is lower than the lower limit value described above, the controller 55 sets the output of the heater 46 to zero, but does not perform heating by the heater 46.

Here, in the third panel module 354R for the red light, the deterioration due to the light energy and the heat is difficult to occur. Therefore, the temperature control device 5C is not required to be provided with the second driver 563. By contraries, even when the temperature control device 5C is provided with the second driver 563, it is possible for the controller 55 of the temperature control device 5C to always drive the second driver 563 with constant output.

### Case of Low Luminance Model

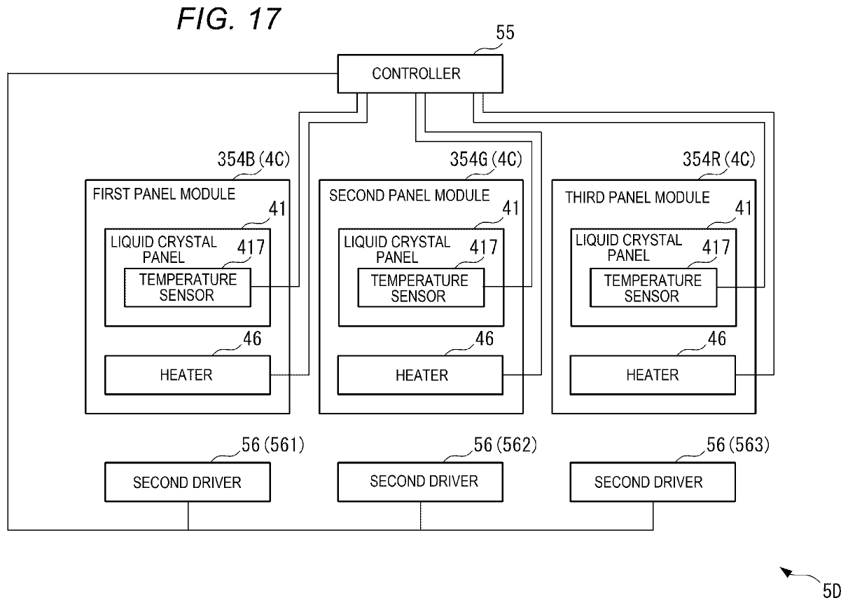

FIG. 17 is a schematic diagram showing a configuration of a temperature control device 5D provided to the projector 1 as the low luminance model.

When the projector 1 is the low luminance model, the C-type panel module 4C is adopted as each of the panel modules 354B, 354G, and 354R as described above.

The projector 1 as the low luminance model is provided with the temperature control device 5D shown in FIG. 17.

The temperature control device 5D controls the temperatures of the liquid crystal elements 411 of the respective panel modules 354B, 354G, and 354R. Similarly to the temperature control device 5C, the temperature control device 5D is provided with the controller 55 and the three second drivers 56.

Out of the three second drivers 56, the second driver 561 makes the cooling gas CA flow through the first panel module 354B, the second driver 562 makes the cooling gas CA flow through the second panel module 354G, and the second driver 563 makes the cooling gas CA flow through the third panel module 354R. Thus, the heat of the liquid crystal elements 411 is transferred to the cooling gas CA from the holding frames 416 and so on of the respective panel modules 354B, 354G, and 354R.

In the temperature control device 5C, for example, when the temperature of the liquid crystal element 411 of the first panel module 354B exceeds the upper limit value of the predetermined optimum temperature range, the controller 55 performs an increase in flow rate of the cooling gas CA according to a rise in output of the second driver 561. The same applies to when the temperature of the liquid crystal element 411 of the second panel module 354G exceeds the upper limit value of the predetermined optimum temperature range, and when the temperature of the liquid crystal element 411 of the third panel module 354R exceeds the upper limit value of the predetermined optimum temperature range.

On the other hand, when the temperature of the liquid crystal element 411 of the first panel module 354B is lower than the lower limit value of the predetermined optimum temperature range, the controller 55 performs at least one of the decrease in flow rate of the cooling gas CA according to the decrease in output of the second driver 561, and heating of the liquid crystal element 411 by the heater 46 according to the rise in output of the heater 46. The same applies to when the temperature of the liquid crystal element 411 of the second panel module 354G is lower than the lower limit value of the predetermined optimum temperature range, and when the temperature of the liquid crystal element 411 of the third panel module 354R is lower than the lower limit value of the predetermined optimum temperature range.

It should be noted that except when the temperature of the liquid crystal element 411 is lower than the lower limit value described above, the controller 55 sets the output of the heater 46 to zero, but does not perform heating by the heater 46 as described above.

Here, in the projector 1 as the low luminance model, the amount of the incident light to each of the panel modules 354B, 354G, and 354R is not relatively high. Therefore, the projector 1 as the low luminance model is not required to be provided with the temperature control device 5D.

Further, even when the projector 1 as the low luminance model is provided with the temperature control device 5D described above, it is possible for the controller to always drive the second drivers 56 with constant output.

It should be noted that in the cooling processing and the heating processing of each of the models, the liquid crystal elements 411 are not affected even when performing the cooling processing and the heating processing within the predetermined optimum temperature range.

Regarding the cooling processing, for example, when the temperature of any one of the three liquid crystal elements 411 exceeds the upper limit value of the predetermined optimum temperature range, and the temperature of the rest of the liquid crystal elements 411 is within the predetermined optimum temperature range, it is possible to perform the cooling processing only on the liquid crystal element 411 the temperature of which exceeds the upper limit value of the optimum temperature range, and it is also possible to perform the cooling processing also on the liquid crystal elements 411 the temperature of which is within the predetermined optimum temperature range.

Regarding the heating processing, for example, when the temperature of any one of the three liquid crystal elements 411 is lower than the lower limit value of the predetermined optimum temperature range, and the temperature of the rest of the liquid crystal elements 411 is within the predetermined optimum temperature range, it is possible to perform the heating processing only on the liquid crystal element 411 the temperature of which is lower than the lower limit value of the predetermined optimum temperature range, and it is also possible to perform the heating processing also on the liquid crystal elements 411 the temperature of which is within the predetermined optimum temperature range.

### Advantages of Embodiment

The projector 1 according to the present embodiment described hereinabove exerts the following advantages.

The projector 1 is provided with the light source 31, the image forming unit 352, and the projection optical unit 37.

The image forming unit 352 is provided with the first panel module 354B, the second panel module 354G, and the third panel module 354R.

When the projector 1 is the ultrahigh luminance model, each of the first panel module 354B, the second panel module 354G, and the third panel module 354R is formed of the A-type panel module 4A as shown in FIG. 13.

When the projector 1 is the high luminance model, each of the first panel module 354B and the second panel module 354G is formed of the A-type panel module 4A, and the third panel module 354R is formed of the B-type panel module as shown in FIG. 14.

When the projector 1 is the medium luminance model, each of the first panel module 354B and the second panel module 354G is formed of the B-type panel module 4B, and the third panel module 354R is formed of the C-type panel module as shown in FIG. 16.

The first panel module 354B constituted by the A-type panel module 4A has a liquid crystal panel 41 for outputting the blue image light. The liquid crystal panel 41 of the first panel module 354B corresponds to a first liquid crystal panel. Further, the first panel module 354B is provided with the heat diffuser 42, the thermoelectric conversion device 44 as the Peltier element, and the cooler The heat diffuser 42 of the first panel module 354B transfers the heat with the liquid crystal panel 41 of the first panel module 354B, and the heat thus received diffuses inside. The thermoelectric conversion device 44 of the first panel module 354B has the first surface 441, and the second surface 442 at the opposite side to the first surface 441. In the first panel module 354B, the first surface 441 corresponds to a first transfer surface, and the second surface 442 corresponds to a first reverse surface. The thermoelectric conversion device 44 transfers heat between the first surface 441 and the heat diffuser 42. The cooler of the first panel module 354B corresponds to a first cooler, and transfers the heat with the second surface 442.

It should be noted that when the first panel module 354B is constituted by the B-type panel module 4B, the cooler 45B corresponds to the first cooler, and transfers the heat with the second surface 442.

The second panel module 354G constituted by the A-type panel module 4A has a liquid crystal panel 41 for outputting the green image light. The liquid crystal panel 41 of the second panel module 354G corresponds to a second liquid crystal panel. Further, the second panel module 354G is provided with the heat diffuser 42, the thermoelectric conversion device 44 as the Peltier element, and the cooler The heat diffuser 42 of the second panel module 354G transfers the heat with the liquid crystal panel 41 of the second panel module 354G, and the heat thus received diffuses inside. The thermoelectric conversion device 44 of the second panel module 354G has the first surface 441, and the second surface 442 at the opposite side to the first surface 441. In the second panel module 354G, the first surface 441 corresponds to a second transfer surface, and the second surface 442 corresponds to a second reverse surface. The thermoelectric conversion device 44 transfers heat between the first surface 441 and the heat diffuser 42. The cooler 45B of the second panel module 354G corresponds to a second cooler, and transfers the heat with the second surface 442.

It should be noted that when the second panel module 354G is constituted by the B-type panel module 4B, the cooler 45B corresponds to the second cooler, and transfers the heat with the second surface 442.

Regardless of which one of the A-type panel module 4A, the B-type panel module 4B, and the C-type panel module 4C the third panel module 354R is constituted by, the third panel module 354R has the liquid crystal panel 41 for outputting the red image light. The liquid crystal panel 41 of the third panel module 354R corresponds to a third liquid crystal panel.

The light source 31 emits the light which enters each of the liquid crystal panel 41 of the first panel module 354B, the liquid crystal panel 41 of the second panel module 354G, and the liquid crystal panel 41 of the third panel module 354R.

The projection optical unit 37 projects the blue image light emitted from the liquid crystal panel 41 of the first panel module 354B, the green image light emitted from the liquid crystal panel 41 of the second panel module 354G, and the red image light emitted from the liquid crystal panel 41 of the third panel module 354R.

According to such a configuration, in the first panel module 354B, the heat generated in the liquid crystal panel 41 is transferred to the heat diffuser 42 to be diffused inside the heat diffuser 42, and is then released to the cooler 45A or the cooler 45B via the thermoelectric conversion device 44. On this occasion, it is possible to actively release the heat of the liquid crystal panel 41 in the cooler 45A or the cooler 45B by the thermoelectric conversion device 44 actively absorbing the heat from the heat diffuser 42 to transfer the heat thus absorbed to the cooler 45A or the cooler 45B. The same applies to the second panel module 354G. Thus, it is possible to prevent the deterioration of the liquid crystal by decreasing the temperature of the liquid crystal constituting the liquid crystal panel 41, and thus, it is possible to achieve an extension of the life of the liquid crystal panel 41.

In particular, the first panel module 354B in which the deterioration of the liquid crystal easily occurs due to the energy of short-wavelength light is provided with the thermoelectric conversion device 44 as the Peltier element. Therefore, it is possible to actively release the heat generated in the liquid crystal panel 41 to the cooler or the cooler 45B by the thermoelectric conversion device 44 actively absorbing the heat from the heat diffuser 42.

Further, the white light includes the blue light, the green light, and the red light. In general, in the white light to be used in image formation, the intensity of the green light is higher than the intensities of other colored light beams. Therefore, the temperature of the liquid crystal panel 41 of the second panel module 354G which the green light enters is apt to rise. In contrast, the second panel module 354G is provided with the thermoelectric conversion device 44 as the Peltier element. Therefore, it is possible to actively release the heat generated in the liquid crystal panel 41 to the cooler 45A or the cooler 45B by the thermoelectric conversion device 44 actively absorbing the heat from the heat diffuser 42.

Therefore, it is possible to achieve the extension of the life of the liquid crystal panels 41 of the respective panel modules 354B, 354G.

On the other hand, when the temperature of the liquid crystal of the liquid crystal panel 41 is low, the responsiveness of the liquid crystal deteriorates, and it is difficult to increase the frame rate of the image to be formed.

In contrast, it is possible to raise the temperature of the liquid crystal panel 41 via the heat diffuser 42 by the thermoelectric conversion device 44 of each of the panel modules 354B, 354G heating the heat diffuser 42 with the first surface 441. Therefore, it is possible to prevent the responsiveness of the liquid crystal constituting the liquid crystal panel 41 from deteriorating, and it is possible to form the image at a high frame rate using the panel modules 354B, 354G. Further, this makes it possible to perform the image formation in good condition with the image forming unit 352, and thus it is possible to obtain a good projection image.

In the image forming unit 352 provided to the projector 1 as the ultrahigh luminance model or the high luminance model, the first panel module 354B and the second panel module 354G are each formed of the A-type panel module 4A provided with the cooler 45A. The cooler 45A is configured so that the liquid cooling medium can flow inside.

According to such a configuration, since the heat transferred to the cooler 45A can be transferred to the liquid cooling medium, it is possible to effectively cool the liquid crystal panel 41 which transfers the heat to the cooler 45A through which the liquid cooling medium flows via the thermoelectric conversion device 44 and the heat diffuser 42. Therefore, it is possible to effectively cool the liquid crystal panel 41 of the first panel module 354B in which the deterioration of the liquid crystal due to the energy of the short-wavelength light is apt to occur, and the liquid crystal panel 41 of the second panel module 354G which is apt to rise in temperature.

It should be noted that in the configuration in which the temperature of the liquid crystal panel is controlled by cooling or heating the liquid cooling medium, since the specific heat of the liquid cooling medium is high, it is difficult to perform prompt temperature control of the liquid crystal panel, and in addition, the electrical power for controlling the temperature of the liquid cooling medium is apt to increase. In contrast, the cooler 45A through which the liquid cooling medium flows is insulated by the thermoelectric conversion device 44 from the heat diffuser 42 having contact with the liquid crystal panel 41. Therefore, by the thermoelectric conversion device 44 controlling the temperature of the liquid crystal panel 41 via the heat diffuser 42, it is possible to promptly perform the rise in temperature of the liquid crystal panel 41. Besides the above, since the thermoelectric conversion device 44 is not required to actively control the temperature of the liquid cooling medium, the power consumption can be suppressed.

In the image forming unit 352 provided to the projector 1 as the ultrahigh luminance model or the high luminance model, the cooler 45A of the first panel module 354B and the cooler 45A of the second panel module 354G are each configured so that the liquid cooling medium can flow inside. The cooler 45A of the first panel module 354B and the cooler 45A of the second panel module 354G are coupled to each other so that the liquid cooling medium can flow setting the cooler 45A of the first panel module 354B upstream. The liquid cooling medium having flowed through the cooler 45A of the first panel module 354B flows into the cooler 45A of the second panel module 354G.

According to such a configuration, by coupling the coolers 45A of the respective panel modules 354B, 354G in series to each other, it is possible to simplify the configuration of the image forming unit 352 compared to when individually piping the coolers 45A. Further, when dividing the flow of the liquid cooling medium pressure-fed from the single first driver 53 to make the liquid cooling medium flow through the coolers 45A, there is a possibility that the cooling performance for the liquid crystal panel 41 by the cooler 45A of the first panel module 354B for which a high heat radiation performance is required does not become sufficiently high. In contrast, by the liquid cooling medium flowing from the cooler 45A of the first panel module 354B to the cooler 45A of the second panel module 354G, it is possible to enhance the cooling performance for the liquid crystal panel 41 of the first panel module 354B. Therefore, it is possible to efficiently cool the liquid crystal panels 41 of the respective panel modules 354B, 354G.

In the image forming unit 352 provided to the projector 1 as the medium luminance model, each of the cooler 45B of the first panel module 354B and the cooler of the second panel module 354G is a heatsink.

According to such a configuration, it is possible to easily configure the cooler 45B for release the heat of the liquid crystal panel 41 transferred from the thermoelectric conversion device 44 as the Peltier element. Therefore, it is possible to simplify the configuration of the image forming unit 352.

In the image forming unit 352 provided to the projector 1 as the medium luminance model, the third panel module 354R is formed of the C-type panel module 4C. Therefore, the third panel module 354R is provided with the heater 46 for heating the liquid crystal panel 41. As described above, the liquid crystal panel 41 of the third panel module 354R corresponds to the third liquid crystal panel.

According to such a configuration, when the temperature of the liquid crystal panel 41 of the third panel module 354R is low, it is possible to heat the liquid crystal panel 41 with the heater 46. Therefore, it is possible to prevent the responsiveness of the liquid crystal constituting the liquid crystal panel 41 from deteriorating, and it is possible to form the image at a high frame rate using the liquid crystal panel 41. It should be noted that it is not necessarily required for the thermoelectric conversion device 44 to actively absorb the heat of the liquid crystal panel 41 of the third panel module 354R which is low in damage of the liquid crystal due to the incident light compared to the liquid crystal panel 41 of the first panel module 354B and the liquid crystal panel 41 of the second panel module 354G. Therefore, by disposing the heater 46 capable of raising the temperature instead of the thermoelectric conversion device 44 capable of not only absorbing heat but also raising the temperature, it is possible to heat the liquid crystal panel 41 of the third panel module 354R. Therefore, it is possible to reduce the manufacturing cost of the image forming unit 352.

In the image forming unit 352 provided to the projector 1 as the ultrahigh luminance model or the high luminance model, the third panel module 354R is constituted by the A-type panel module 4A or the B-type panel module 4B. Therefore, the third panel module 354R is provided with the heat diffuser 42, the thermoelectric conversion device 44, and one of the cooler 45A and the cooler 45B.

The heat diffuser 42 of the third panel module 354R corresponds to a third heat diffuser, and transfers the heat with the liquid crystal panel 41, and the heat thus received diffuses inside.

The thermoelectric conversion device 44 of the third panel module 354R corresponds to a third Peltier element. The thermoelectric conversion device 44 has the first surface 441 and the second surface 442, and transfers heat between the first surface 441 and the heat diffuser 42. In the third panel module 354R, the first surface 441 corresponds to a third transfer surface, and the second surface 442 corresponds to a third reverse surface at an opposite side to the third transfer surface.

The cooler 45A or the cooler 45B of the third panel module 354R corresponds to a third cooler. The cooler 45A or the cooler 45B of the third panel module 354R transfers the heat with the second surface 442.

According to such a configuration, it is possible to perform the heat absorption and heating on the liquid crystal panel 41 using the thermoelectric conversion device 44 of the third panel module 354R. Therefore, as described above, it is possible to promptly perform cooling and heating on the liquid crystal panel 41 of the third panel module 354R, and thus, it is possible to perform prompt temperature control of the liquid crystal panel 41.

In the image forming unit 352 provided to the projector 1 as the ultrahigh luminance model, the panel modules 354B, 354G, and 354R are each formed of the A-type panel module 4A. The coolers 45A of the respective panel modules 354B, 354G, and 354R are each configured so that the liquid cooling medium can flow inside.

According to such a configuration, as described above, it is possible to promptly and effectively cool the liquid crystal panels 41 corresponding respectively to the coolers 45A, and in addition, it is possible to promptly and effectively heat the respective liquid crystal panels 41. Besides the above, it is possible to suppress the power consumption compared to the configuration of cooling or heating the liquid crystal panel 41 via the liquid cooling medium.

In the image forming unit 352 provided to the projector 1 as the high luminance model, each of the first panel module 354B and the second panel module 354G is formed of the A-type panel module 4A, and the third panel module 354R is formed of the B-type panel module 4B. Each of the cooler 45A of the first panel module 354B and the cooler of the second panel module 354G is configured so that the liquid cooling medium described above can flow inside. The cooler 45B of the third panel module 354R is a heatsink.

According to such a configuration, as described above, it is possible to promptly and effectively cool each of the liquid crystal panel 41 of the first panel module 354B and the liquid crystal panel 41 of the second panel module 354G.

Further, compared to when the cooler 45B of the third panel module 354R is the cooler 45A through which the liquid cooling medium flows, it is possible to simply configure the cooler 45B of the third panel module 354R, and in addition, it is possible to reduce the manufacturing cost of the image forming unit 352.

In the image forming units 352 provided to the projectors 1 as the ultrahigh luminance model, the high luminance model, and the medium luminance model, the heat diffuser 42 of the first panel module 354B has the contact portion 424 and the extending portion 425. In the first panel module 354B, the contact portion 424 corresponds to a first contact portion, and the extending portion 425 corresponds to a first extending portion.

The contact portion 424 of the first panel module 354B makes contact with the liquid crystal panel 41 of the first panel module 354B. The extending portion 425 extends from the contact portion 424 toward the +Y direction of getting away from the pixel area PA for emitting the blue image light in the liquid crystal panel 41 of the first panel module 354B. The first surface 441 as the first transfer surface in the first panel module 354B has contact with the extending portion 425 of the first panel module 354B.

The heat diffuser 42 of the second panel module 354G has the contact portion 424 and the extending portion 425. In the second panel module 354G, the contact portion 424 corresponds to a second contact portion, and the extending portion 425 corresponds to a second extending portion.

The contact portion 424 of the second panel module 354G makes contact with the liquid crystal panel 41 of the second panel module 354G. The extending portion 425 extends from the contact portion 424 toward the +Y direction of getting away from the pixel area PA for emitting the green image light in the liquid crystal panel 41 of the second panel module 354G. The first surface 441 as the second transfer surface in the second panel module 354G has contact with the extending portion 425 of the second panel module 354G.

According to such a configuration, in the first panel module 354B, the heat transferred from the liquid crystal panel 41 to the heat diffuser 42 can efficiently be absorbed by the thermoelectric conversion device 44, and the heat transferred from the thermoelectric conversion device 44 to the heat diffuser 42 can efficiently be transferred to the liquid crystal panel 41.

Further, in the second panel module 354G, the heat transferred from the liquid crystal panel 41 to the heat diffuser 42 can efficiently be absorbed by the thermoelectric conversion device 44, and the heat transferred from the thermoelectric conversion device 44 to the heat diffuser 42 can efficiently be transferred to the liquid crystal panel 41.

Therefore, it is possible to promptly perform the temperature control of the liquid crystal panels 41 of the respective panel modules 354B, 354G.

### Modifications of Embodiment

The present disclosure is not limited to the embodiment described above, but includes modifications, improvements, and so on in the range in which the advantages of the present disclosure can be achieved.

In the embodiment described above, it is assumed that in the image forming unit 352 in the ultrahigh luminance model, each of the first panel module 354B, the second panel module 354G, and the third panel module 354R is formed of the A-type panel module 4A. It is assumed that in the image forming unit 352 in the high luminance model, each of the first panel module 354B and the second panel module 354G is formed of the A-type panel module 4A, and the third panel module 354R is formed of the B-type panel module 4B. It is assumed that in the image forming unit 352 in the medium luminance model, each of the first panel module 354B and the second panel module 354G is formed of the B-type panel module 4B, and the third panel module 354R is formed of the C-type panel module 4C. It is assumed that in the image forming unit 352 in the low luminance model, the panel modules 354B, 354G, and 354R are each formed of the C-type panel module 4C.

However, this is not a limitation, and it is sufficient for the first panel module 354B to be formed of one of the panel modules 4A, 4B, and 4C. The same applies to the second panel module 354G and the third panel module 354R. Therefore, the image forming unit 352, for example, can be provided with the first panel module 354B formed of the A-type panel module 4A, the second panel module 354G formed of the B-type panel module 4B, and the third panel module 354R formed of the C-type panel module 4C.

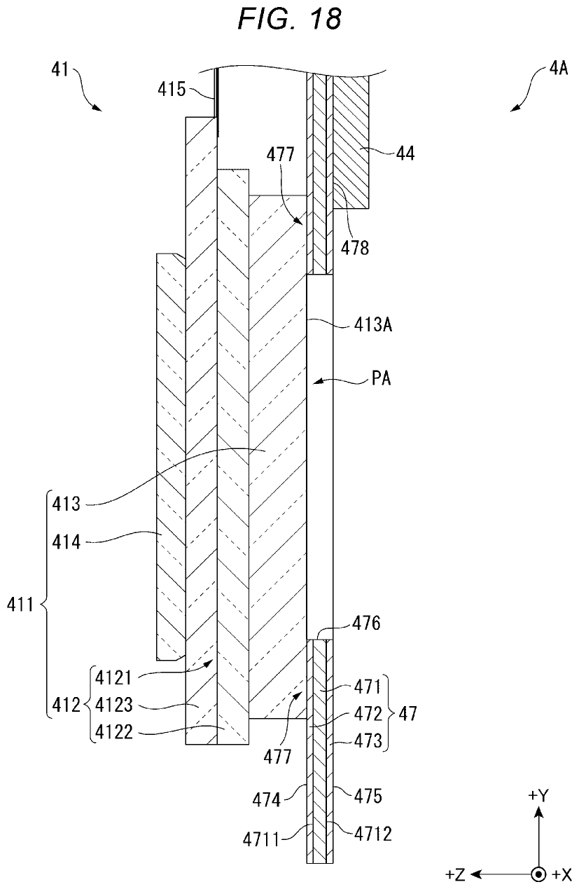

FIG. 18 is a cross-sectional view showing a part of the A-type panel module 4A in an enlarged manner, wherein the A-type panel module 4A is provided with a heat diffuser 47 which is a modification of the heat diffuser 42 instead of the heat diffuser 42. It should be noted that the illustration of the holding frame 416, the holding member 43, and the cooler 45A is omitted in FIG. 18.

In the embodiment described above, it is assumed that the heat diffuser 42 is formed of the vapor chamber VC provided with the sealed housing VC1 containing the working fluid. However, this is not a limitation, and it is possible for the heat diffuser to be provided with a configuration different from the vapor chamber VC. For example, it is possible to adopt the heat diffuser 47 shown in FIG. 18 instead of the heat diffuser 42.

As shown in FIG. 18, the heat diffuser 47 is provided with a support member 471, a first sheet 472, and a second sheet 473.

The support member 471 is a planar member formed of metal such as aluminum, and supports the first sheet 472 and the second sheet 473. The support member 471 has a first surface 4711 as a surface at the liquid crystal element 411 side, and a second surface 4712 at an opposite side to the first surface 4711.

The first sheet 472 is disposed on the first surface 4711 so as to cover the first surface 4711 at the +Z direction side, and the second sheet 473 is disposed on the second surface 4712 so as to cover the second surface 4712 at the -Z direction side. The first sheet 472 and the second sheet 473 are each formed of a graphite sheet or a graphene sheet. In other words, the heat diffuser 47 is a thermally-conductive body including at least one of the graphite sheet and the graphene sheet.

Such a heat diffuser 47 is provided with a first surface 474, a second surface 475, an opening 476, a contact portion 477, and an extending portion 478.

The first surface 474 is a surface opposed to the liquid crystal element 411 in the heat diffuser 47. The first surface 474 is formed of the first sheet 472.

The second surface 475 is a surface at an opposite side to the first surface 474 in the heat diffuser 47. The second surface 475 is formed of the second sheet 473.

The opening 476 is a through opening which penetrates the heat diffuser 47 along the +Z direction, and transmits the light entering the liquid crystal element 411 toward the +Z direction. The opening 476 is formed to have a substantially rectangular shape corresponding to the pixel area PA when viewed from the light incidence side.

The contact portion 477 is disposed on a circumferential edge of the opening 476 on the first surface 474. The contact portion 477 makes contact with the plane of incidence of light 413A as the heat transfer surface to receive the heat of the liquid crystal element 411 from the plane of incidence of light 413A. Specifically, the contact portion 477 is formed of the first sheet 472.

The extending portion 478 is a portion extending in a direction crossing the incident direction of the light to the liquid crystal element 411 from the contact portion 477 in the heat diffuser 47. In the detailed description, the extending portion 478 is a portion extending from the contact portion 477 toward the +Y direction crossing the +Z direction. To the portion corresponding to the extending portion 478 in the second surface 475, there is coupled the thermoelectric conversion device 44.

In such a heat diffuser 47, the heat of the liquid crystal element 411 transferred to the contact portion 477 having contact with the plane of incidence of light 413A is diffused on the first sheet 472 constituting the contact portion 477, and in addition, transferred to the support member 471 to be diffused in the support member 471. Further, the heat transferred to the support member 471 is further transferred to the second sheet 473, and is diffused in the second sheet 473. The heat diffused in the heat diffuser 47 is absorbed by the thermoelectric conversion device coupled to the extending portion 478.

The heat diffuser 47 can be adopted instead of the heat diffuser 42 in the A-type panel module 4A and the B-type panel module 4B. The panel modules 4A, 4B provided with such a heat diffuser 47 instead of the heat diffuser 42 exert substantially the same advantages as those of the panel modules 4A, 4B provided with the heat diffuser 42, and further exert the following advantages.

The heat diffuser 47 is a thermally-conductive body including at least one of the graphite sheet and the graphene sheet.

Here, the graphite sheet and the graphene sheet diffuse the heat transferred thereto inside the sheet. Therefore, by adopting the thermally-conductive body including such a sheet as the heat diffuser 47, it is possible to make it easy to transfer the heat transferred from the plane of incidence of light 413A as the heat transfer surface to the extending portion 478, and by extension, it is possible to make it easy to absorb the heat of the liquid crystal element 411 transferred to the heat diffuser 47 using the thermoelectric conversion device 44. Therefore, since it is possible to make it easy to release the heat of the liquid crystal element 411 with the coolers 45A, 45B, it is possible to increase the cooling efficiency for the liquid crystal element 411.

It should be noted that it is assumed that the heat diffuser 47 is provided with the support member 471, the first sheet 472, and the second sheet 473. However, this is not a limitation, and it is possible to adopt a configuration in which the heat diffuser 47 is provided with just one of the first sheet 472 and the second sheet 473. Further, providing the liquid crystal element 411 and the thermoelectric conversion device 44 can be coupled to each other, it is possible adopt a configuration in which the heat diffuser has just one of the sheets, and the support member 471 is eliminated.

In the embodiment described above, it is assumed that the controller 55 of the temperature control devices 5A, 5B, 5C, and 5D controls the operations of the thermoelectric conversion device 44, the first driver 53, and the second driver 56 based on the temperature of the liquid crystal element 411. However, this is not a limitation, and it is possible for the controller 55 to control the operations of the thermoelectric conversion device 44, the first driver 53, and the second driver 56 based on other indexes. For example, it is possible for the controller 55 to control the operations of the thermoelectric conversion device 44, the first driver 53, and the second driver 56 based on an amount the outgoing light from the light source 31.

In the embodiment described above, it is assumed that the cooler 45A is the cold plate configured so that the liquid cooling medium can flow inside, and the cooler 45B is the heatsink. However, this is not a limitation, and the cooler is not limited to the configuration described above.

In the present embodiment described above, it is assumed that the thermoelectric conversion device 44 is the Peltier element. However, this is not a limitation, and it is possible to adopt the thermoelectric conversion device provided with other configurations in the panel modules 4A, 4B.

In the embodiment described above, it is assumed that the C-type panel module 4C is provided with the heater 46. However, this is not a limitation, and the C-type panel module 4C is not required to be provided with the heater 46.

In the embodiment described above, it is assumed that in the projector 1 as the high luminance model, the first panel module 354B and the second panel module 354G are each formed of the A-type panel module 4A provided with the cooler 45A through which the liquid cooling medium can flow. However, this is not a limitation, and it is possible to adopt a configuration in which one of the first panel module 354B and the second panel module 354G is formed of the A-type panel module 4A, and the other thereof is formed of the panel module other than the A-type panel module 4A.

Alternatively, in the projector 1 as the medium luminance model or the low luminance model, it is possible for one of the first panel module 354B and the second panel module 354G to be formed of the A-type panel module 4A.

In the embodiment described above, it is assumed that the plane of incidence of light 413A in the incident side dust-proof substrate 413 provided to the liquid crystal element 411 is the heat transfer surface with which the contact portion 427, 477 of the heat diffuser 42, 47 has contact, and which transfers the heat of the liquid crystal element 411 to the heat diffuser 42, 47. However, this is not a limitation, and a portion other than the plane of incidence of light 413A can be the heat transfer surface in the liquid crystal element 411. For example, a side surface crossing the plane of incidence of light in at least one of the opposed substrate 4122, the pixel substrate 4123, the incident side dust-proof substrate 413, and the exit side dust-proof substrate 414 can be the heat transfer surface.

Further, the contact portion 424, 477 of the heat diffuser 42, 47 is not required to have direct contact with the liquid crystal element 411. For example, it is possible for the contact portion 424, 477 to have contact with the heat transfer member to be coupled to the liquid crystal element 411 in a heat-transferable manner. The same applies to the thermoelectric conversion device 44 having contact with the extending portion 425, 478, and the cooler 45A, 45B having contact with the second surface 442 of the thermoelectric conversion device 44.

Further, the opening 423, 476 can be eliminated from the heat diffuser 42, 47 depending on an arrangement of the heat diffuser 42, 47 with respect to the liquid crystal element 411.

In the embodiment described above, it is assumed that each of the panel modules 4A, 4B, and 4C modulates the incident light with the liquid crystal panel 41, and then emits the light thus modulated along the incident direction of the light to the liquid crystal panel 41. In other words, it is assumed that the panel modules 4A, 4B, and 4C are each a transmissive liquid crystal panel module. However, this is not a limitation, and it is possible for the panel module according to the present disclosure to be a reflective panel module which modulates the incident light with the liquid crystal panel, and then emits the light thus modulated toward an opposite direction to the incident direction of the light to the liquid crystal panel.

In the present embodiment described above, there is illustrated the projector 1 as an electronic apparatus provided with the image forming unit 352. However, this is not a limitation, the electronic apparatus provided with the image forming unit according to the present disclosure is not limited to a projector, and can also be an electronic apparatus provided with other configurations. As such an electronic apparatus, there can be cited, for example, an illumination device.

### Conclusion of Present Disclosure

Hereinafter, the conclusion of the present disclosure will supplementarily be noted.

### Supplementary Note 1

An image forming including a first panel module having a first liquid crystal panel configured to output blue image light, a second panel module having a second liquid crystal panel configured to output green image light, and a third panel module having a third liquid crystal panel configured to output red image light, wherein the first panel module includes a first heat diffuser which is configured to transfer heat with the first liquid crystal panel, and in which the heat received diffuses, a first Peltier element which has a first transfer surface, and a first reverse surface at an opposite side to the first transfer surface, and which transfers heat between the first transfer surface and the first heat diffuser, and a first cooler configured to transfer heat with the first reverse surface, and the second panel module includes a second heat diffuser which is configured to transfer heat with the second liquid crystal panel, and in which the heat received diffuses, a second Peltier element which has a second transfer surface, and a second reverse surface at an opposite side to the second transfer surface, and which transfers heat between the second transfer surface and the second heat diffuser, and a second cooler configured to transfer heat with the second reverse surface.

According to such a configuration, the heat generated in the first liquid crystal panel is transferred to the first heat diffuser to be diffused inside the first heat diffuser, and is then released to the first cooler via the first Peltier element. On this occasion, by the first Peltier element actively absorbing the heat from the first heat diffuser, and the transferring the heat absorbed to the first cooler, it is possible to actively release the heat of the first liquid crystal panel in the first cooler. The same applies to the second panel module. Thus, it is possible to prevent the deterioration of the liquid crystal by decreasing the temperature of the liquid crystal constituting the liquid crystal panel, and thus, it is possible to achieve an extension of the life of the liquid crystal panel.

In particular, the first panel module having the first liquid crystal panel in which the deterioration of the liquid crystal easily occurs due to the energy of short-wavelength light is provided with the first Peltier element. Therefore, by the first Peltier element actively absorbing the heat from the first heat diffuser, it is possible to actively release the heat generated in the first liquid crystal panel to the first cooler.

Further, the white light includes the blue light, the green light, and the red light. In general, in the white light to be used in image formation, the intensity of the green light is higher than the intensities of other colored light beams. Therefore, the temperature of the second liquid crystal panel which the green light enters is apt to rise. In contrast, the second panel module having the second liquid crystal panel is provided with the Peltier element. Therefore, by the second Peltier element actively absorbing the heat from the second heat diffuser, it is possible to actively release the heat generated in the second liquid crystal panel to the second cooler.

Therefore, it is possible to achieve an extension of the lives of the first liquid crystal panel and the second liquid crystal panel.

On the other hand, when the temperature of the liquid crystal of the liquid crystal panel is low, the responsiveness of the liquid crystal deteriorates, and it is difficult to increase the frame rate of the image to be formed.

In contrast, the first panel module and the second panel module are each provided with the Peltier element. Thus, by the Peltier element heating the heat diffuser with the first transfer surface, it is possible to raise the temperature of the liquid crystal panel via the heat diffuser. Therefore, it is possible to prevent the responsiveness of the liquid crystal constituting the liquid crystal panel from deteriorating, and it is possible to form the image at a high frame rate using the first liquid crystal panel and the second liquid crystal panel.

### Supplementary Note 2

In the image forming unit described in Supplementary Note 1, at lease one of the first cooler and the second cooler is configured so that a liquid cooling medium flows inside.

According to such a configuration, since the heat transferred to the cooler can be transferred to the liquid cooling medium, it is possible to effectively cool the liquid crystal panel which transfers the heat to the cooler through which the liquid cooling medium flows via the Peltier element and the heat diffuser. Therefore, it is possible to effectively cool at least one of the first liquid crystal panel in which the deterioration of the liquid crystal due to the energy of the short-wavelength light is apt to occur, and the second liquid crystal panel which is apt to rise in temperature.

It should be noted that in the configuration in which the temperature of the liquid crystal panel is controlled by cooling or heating the liquid cooling medium, since the specific heat of the liquid cooling medium is high, it is difficult to perform prompt temperature control of the liquid crystal panel, and in addition, the electrical power for controlling the temperature of the liquid cooling medium is apt to increase. In contrast, the cooler through which the liquid cooling medium flows is insulated by the Peltier element from the heat diffuser having contact with the liquid crystal panel. Therefore, by the Peltier element controlling the temperature of the liquid crystal panel via the heat diffuser, it is possible to promptly perform the rise in temperature of the liquid crystal panel. Besides the above, since the Peltier element is not required to actively control the temperature of the liquid cooling medium, the power consumption can be suppressed.

### Supplementary Note 3

In the image forming unit described in

Supplementary Note 2, each of the first cooler and the second cooler is configured so that the liquid cooling medium flows inside, the first cooler and the second cooler are coupled to each other so that the liquid cooling medium flows setting the first cooler upstream, and the liquid cooling medium flowed through the first cooler flows through the second cooler.

According to such a configuration, by coupling the first cooler and the second cooler in series to each other, it is possible to simplify the configuration of the image forming unit compared to when individually piping the first cooler and the second cooler. Further, when dividing the flow of the liquid cooling medium pressure-fed from a single pump to make the liquid cooling medium flow through the respective coolers, there is a possibility that the cooling performance for the liquid crystal panel by the cooler for which a high heat radiation performance is required does not become sufficiently high. In contrast, by the liquid cooling medium flowing from the first cooler to the second cooler, it is possible to enhance the cooling performance for the first liquid crystal panel by the first cooler. Therefore, it is possible to effectively cool the first liquid crystal panel and the second liquid crystal panel.

### Supplementary Note 4

In the image forming unit described in Supplementary Note 1, at lease one of the first cooler and the second cooler is a heatsink.

According to such a configuration, it is possible to easily configure the cooler for release the heat of the liquid crystal panel transferred from the Peltier element. Therefore, it is possible to simplify the configuration of the image forming unit.

### Supplementary Note 5

In the image forming unit described in any one of Supplementary Note 1 through Supplementary Note 4, the third panel module includes a heater configured to heat the third liquid crystal panel.

According to such a configuration, when the temperature of the third liquid crystal panel is low, it is possible to heat the third liquid crystal panel with the heater. Therefore, it is possible to prevent the responsiveness of the liquid crystal constituting the third liquid crystal panel from deteriorating, and it is possible to form the image at a high frame rate using the third liquid crystal panel. It should be noted that the Peltier element is not necessarily required to actively absorb the heat of the third liquid crystal panel which is lower in damage of the liquid crystal due to the incident light compared to the first liquid crystal panel and the second liquid crystal panel. Therefore, by disposing the heater capable of raising the temperature instead of the Peltier element capable of not only absorbing heat but also raising the temperature, it is possible to heat the third liquid crystal panel. Therefore, it is possible to reduce the manufacturing cost of the image forming unit.

### Supplementary Note 6

In the image forming unit described in Supplementary Note 1, the third panel module includes a third heat diffuser which is configured to transfer heat with the third liquid crystal panel, and in which the heat received diffuses, a third Peltier element which has a third transfer surface, and a third reverse surface at an opposite side to the third transfer surface, and which transfers heat between the third transfer surface and the third heat diffuser, and a third cooler configured to transfer heat with the third reverse surface.

According to such a configuration, it is possible to perform the heat absorption and heating on the third liquid crystal panel using the Peltier element. Therefore, as described above, it is possible to promptly perform cooling and heating on the third liquid crystal panel, and thus, it is possible to perform prompt temperature control of the third liquid crystal panel.

### Supplementary Note 7

In the image forming unit described in Supplementary Note 6, each of the first cooler, the second cooler, and the third cooler is configured so that a liquid cooling medium flows inside.

According to such a configuration, as described above, it is possible to promptly and effectively cool the liquid crystal panels corresponding respectively to the coolers, and in addition, it is possible to promptly and effectively heat the respective liquid crystal panels. Besides the above, it is possible to suppress the power consumption compared to the configuration of cooling or heating the liquid crystal panels via the liquid cooling medium.

### Supplementary Note 8

In the image forming unit described in Supplementary Note 6, each of the first cooler and the second cooler is configured so that a liquid cooling medium flows inside, and the third cooler is a heatsink.

According to such a configuration, as described above, even when the intensity of the light entering each of the first liquid crystal panel and the second liquid crystal panel is high, it is possible to promptly and effectively cool each of the first liquid crystal panel and the second liquid crystal panel.

Further, compared to when the third cooler is the cooler through which the liquid cooling medium flows, it is possible to simply configure the third cooler, and in addition, it is possible to reduce the manufacturing cost of the image forming unit.

### Supplementary Note 9

In the image forming unit described in any one of Supplementary Note 1 through Supplementary Note 8, the first heat diffuser includes a first contact portion having contact with the first liquid crystal panel, and a first extending portion extending from the first contact portion in a direction of getting away from an area configured to emit the blue image light in the first liquid crystal panel, the first transfer surface has contact with the first extending portion, the second heat diffuser includes a second contact portion having contact with the second liquid crystal panel, and a second extending portion extending from the second contact portion in a direction of getting away from an area configured to emit the green image light in the second liquid crystal panel, and the second transfer surface has contact with the second extending portion.

According to such a configuration, the first transfer surface of the first Peltier element has contact with the first extending portion extending from the first contact portion in the first heat diffuser. Thus, the heat transferred from the first liquid crystal panel to the first heat diffuser can efficiently be absorbed by the first Peltier element, and the heat transferred from the first Peltier element to the first heat diffuser can efficiently be transferred to the first liquid crystal panel.

Further, the second transfer surface of the second Peltier element has contact with the second extending portion extending from the second contact portion in the second heat diffuser. Thus, the heat transferred from the second liquid crystal panel to the second heat diffuser can efficiently be absorbed by the second Peltier element, and the heat transferred from the second Peltier element to the second heat diffuser can efficiently be transferred to the second liquid crystal panel.

Therefore, it is possible to promptly perform the temperature control of each of the first liquid crystal panel and the second liquid crystal panel.

### Supplementary Note 10

A projector including the image forming unit described in any one of Supplementary Note 1 through Supplementary Note 9, a light source configured to emit light which enters each of the first liquid crystal panel, the second liquid crystal panel, and the third liquid crystal panel, and a projection optical unit configured to project the blue image light emitted from the first liquid crystal panel, the green image light emitted from the second liquid crystal panel, and the red image light emitted from the third liquid crystal panel.

According to such a configuration, as described above, it is possible to efficiently perform cooling and heating on at least the first liquid crystal panel and the second liquid crystal panel. This makes it possible to perform the image formation in good condition with the image forming unit, and thus it is possible to obtain a good projection image.

What is claimed is:

1. An image forming unit comprising:
a first panel module having a first liquid crystal panel configured to output blue image light;
a second panel module having a second liquid crystal panel configured to output green image light; and
a third panel module having a third liquid crystal panel configured to output red image light, wherein
the first panel module includes
a first heat diffuser which is configured to transfer heat with the first liquid crystal panel, and in which the heat received diffuses,
a first Peltier element which has a first transfer surface, and a first reverse surface at an opposite side to the first transfer surface, and which transfers heat between the first transfer surface and the first heat diffuser, and
a first cooler configured to transfer heat with the first reverse surface, and
the second panel module includes
a second heat diffuser which is configured to transfer heat with the second liquid crystal panel, and in which the heat received diffuses,
a second Peltier element which has a second transfer surface, and a second reverse surface at an opposite side to the second transfer surface, and which transfers heat between the second transfer surface and the second heat diffuser, and
a second cooler configured to transfer heat with the second reverse surface.

2. The image forming unit according to claim 1, wherein
at lease one of the first cooler and the second cooler is configured so that a liquid cooling medium flows inside.

3. The image forming unit according to claim 2, wherein
each of the first cooler and the second cooler is configured so that the liquid cooling medium flows inside,
the first cooler and the second cooler are coupled to each other so that the liquid cooling medium flows setting the first cooler upstream, and
the liquid cooling medium flowed through the first cooler flows through the second cooler.

4. The image forming unit according to claim 1, wherein
at lease one of the first cooler and the second cooler is a heatsink.

5. The image forming unit according to claim 1, wherein
the third panel module includes a heater configured to heat the third liquid crystal panel.

6. The image forming unit according to claim 1, wherein
the third panel module includes
a third heat diffuser which is configured to transfer heat with the third liquid crystal panel, and in which the heat received diffuses,
a third Peltier element which has a third transfer surface, and a third reverse surface at an opposite side to the third transfer surface, and which transfers heat between the third transfer surface and the third heat diffuser, and
a third cooler configured to transfer heat with the third reverse surface.

7. The image forming unit according to claim 6, wherein
each of the first cooler, the second cooler, and the third cooler is configured so that a liquid cooling medium flows inside.

8. The image forming unit according to claim 6, wherein
each of the first cooler and the second cooler is configured so that a liquid cooling medium flows inside, and
the third cooler is a heatsink.

9. The image forming unit according to claim 1, wherein
the first heat diffuser includes
a first contact portion having contact with the first liquid crystal panel, and
a first extending portion extending from the first contact portion in a direction of getting away from an area configured to emit the blue image light in the first liquid crystal panel,
the first transfer surface has contact with the first extending portion,
the second heat diffuser includes
a second contact portion having contact with the second liquid crystal panel, and
a second extending portion extending from the second contact portion in a direction of getting away from an area configured to emit the green image light in the second liquid crystal panel, and
the second transfer surface has contact with the second extending portion.

10. A projector comprising:
the image forming unit according to claim 1;
a light source configured to emit light which enters each of the first liquid crystal panel, the second liquid crystal panel, and the third liquid crystal panel; and
a projection optical unit configured to project the blue image light emitted from the first liquid crystal panel, the green image light emitted from the second liquid crystal panel, and the red image light emitted from the third liquid crystal panel.
